(19) United States
(12) Patent Application Publication
(10) Pub. No.: US 2008/0241430 A1
(43) Pub. Date: Oct. 2, 2008

(54) CELLULOSE COMPOUND COMPOSITION, CELLULOSE COMPOUND FILM, OPTICALLY COMPENSATORY SHEET, POLARIZING PLATE AND LIQUID CRYSTAL DISPLAY DEVICE

(75) Inventor: Tomoko Imai, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/057,766

(22) Filed: Mar. 28, 2008

(30) Foreign Application Priority Data
Mar. 28, 2007 (JP) 2007-085940
Oct. 24, 2007 (JP) 2007-276617

(51) Int. Cl. C09K 19/00; C08B 15/00

(52) U.S. Cl. 428/1.5; 536/56; 252/299.61

(57) ABSTRACT

A cellulose compound composition includes a cellulose compound that includes (A) an aliphatic acyl group having a carbon number of 5 to 30 and (B) an acyl group containing an aromatic group.

### BACKGROUND OF THE INVENTION

1. Field of the Invention

The present invention relates to a cellulose compound composition, a film, an optically compensatory sheet, a polarizing plate and a liquid crystal display device. More specifically, the present invention relates to a cellulose compound film having large absolute values of in-plane retardation (Re) and retardation (Rth) in the thickness direction and small humidity dependency of Re and Rth and having appropriate glass transition temperature and mechanical properties, and an optically compensatory sheet, a polarizing plate and a liquid crystal display device, each using the cellulose compound film.

2. Description of the Related Art

With recent prevalence of a liquid crystal display device, the level required of the display performance and durability becomes higher, and the problems to be solved are to increase the response speed and compensate the viewing angle in a wider range for satisfying the contrast, color balance and the like of a displayed image when observed from an oblique direction. In order to solve these problems, display elements of VA (vertical alignment) mode, OCB (optical compensated bend) mode and IPS (in-plane switching) mode are developed, and optical film materials having various retardation developing properties according to respective liquid crystal modes are demanded. Above all, the phase difference film is required to control the values of in-plane retardation (Re) and retardation (Rth) in the thickness direction according to various liquid crystal modes.

A cellulose acylate film is widely used as a polarizing plate protective film for liquid crystal display devices because of its transparency and toughness. For example, an optical film obtained by film-forming a fatty acid cellulose ester such as cellulose acetate propionate and cellulose acetate butyrate is proposed (JP-A-2000-352620 (the term “JP-A” as used herein means an “unexamined published Japanese patent application”)). However, Re and Rth obtainable in such a film are limited and the film is not satisfied as a phase difference film. Also, a highly stretched film formed of a cellulose mixed acylate comprising a linear carboxylic acid having a carbon number of 5 to 22 and an acetic acid is recently proposed (JP-A-2006-249221). This film is, however, an optical film exhibiting low birefringence. Furthermore, an optical film obtained by film-forming an aromatic carboxylic acid-mixed acylate is recently proposed (JP-A-2006-328298).

However, such a film still has a problem that not only Re and Rth enough for the polarizing plate protective film additionally having a function as a phase difference film are unobtainable but also the retardation varies due to humidity fluctuation to cause generation of white spots.

### SUMMARY OF THE INVENTION

In consideration of these problems, an object of the present invention is to provide a cellulose compound film undergoing less change in the in-plane retardation (Re) and retardation (Rth) in the thickness direction due to humidity fluctuation and having high absolute values of Re and Rth, and an optically compensatory film, a polarizing plate and a liquid crystal display device each using the cellulose compound film.

The above-described object of the present invention is attained by the following means.

[1] cellulose compound composition comprising:

a cellulose compound that comprises (A) an aliphatic acyl group having a carbon number of 5 to 30 and (B) an acyl group containing an aromatic group.

[2] The cellulose compound composition as described in [1], wherein

the cellulose compound further comprises (C) an aliphatic acyl group having a carbon number of 2 to 4.

[3] The cellulose compound composition as described in [2], wherein

the cellulose compound satisfies a following formula (I):

2.4≦DSA+DSB+DSC≦3.0 Formula (I)

wherein

DSA, DSB and DSC represent substitution degrees of the acyl group (A), the acyl group (B) and the acyl group (C), respectively.

[4] The cellulose compound composition as described in [1], wherein

the cellulose compound satisfies a following formula (II):

0.1<DSA<0.8 Formula (II)

wherein

DSA represents a substitution degree of the acyl group (A).

[5] The cellulose compound composition as described in [1], wherein

the cellulose compound satisfies a following formula (III):

0.1<DSB<0.8 Formula (III)

wherein

DSB represents a substitution degree of the acyl group (B).

[6] The cellulose compound composition as described in [1], wherein

the cellulose compound satisfies a following formula (IV) or (IV-I):

0.7DSB≦DSB₆ Formula (IV)

DSB₆≦0.3DSB Formula (IV-I)

wherein

DSB represents a substitution degree of the acyl group (B), and

DSB₆ represents a substitution degree of the acyl group (B) at 6-position thereof.

[7] The cellulose compound composition as described in [1], wherein

the acyl group (A) is selected from the group consisting of a hexanoyl group, an octanoyl group, a 2-ethylhexanoyl group, a dodecanoyl group, an octadecanoyl group and a cyclohexanoyl group.

[8] The cellulose compound composition as described in [1], wherein

the acyl group (B) is selected from the group consisting of a benzoyl group, a phenylbenzoyl group and a 4-heptylbenzoyl group.

[9] A cellulose compound film formed of the cellulose compound composition as described in [1].

[10] A phase difference film comprising the cellulose compound film as described in [9].

[11] An optically compensatory film comprising:

the cellulose compound film as described in [9]; and

an optically anisotropic layer formed by aligning a liquid crystalline compound.

[12] An antireflection film comprising:

the cellulose compound film as described in [9]; and

an antireflection layer.

[13] A polarizing plate comprising:

a polarizing film; and

two protective films between which the polarizing film is sandwiched,

wherein at least one of the two protective films comprises the cellulose compound film as described in [9].

[14] An image display device comprising:

the cellulose compound film as described in [9].

### DETAILED DESCRIPTION OF THE INVENTION

The present invention is described in detail below.

### [Cellulose Compound]

The cellulose compound contained in the cellulose compound composition of the present invention contains (A) an aliphatic acyl group having a carbon number of 5 to 30 and (B) an acyl group containing an aromatic group.

### (Aliphatic Acyl Group (A))

The aliphatic acyl group (A) for use in the present invention is an acyl group having a carbon number of 5 to 30 and may be linear or branched or may contain a cyclic structure or an unsaturated bond, and these are not particularly limited. The aliphatic acyl group is preferably an acyl group having a carbon number of 5 to 20, more preferably from 6 to 18, and most preferably from 8 to 18. Specific examples thereof include a pentanoyl group, a hexanoyl group, a heptanoyl group, an octanoyl group, a nonanoyl group, a decanoyl group, an undecanoyl group, a dodecanoyl group, a tridecanoyl group, a tetradecanoyl group, a pentatetradecanoyl group, a hexadecanoyl group, a heptadecanoyl group, an octadecanoyl group, a nonadecanoyl group, an eicosanoyl group, a heneicosanoyl group, a docosanoyl group, a tricosanoyl group, a tetracosanoyl group, a hexacosanoyl group, a heptacosanoyl group, an octacosanoyl group, a triacosanoyl group, a trimethylacetyl group, a 2-methylbutyryl group, an isovaleryl group, a 2-ethylbutyryl group, a 2,2-dimethylbutyryl group, a tert-butylacetyl group, a 2-methylvaleryl group, a 3-methylvaleryl group, a 4-methylvaleryl group, a 2-propylpentanoyl group, a 2-methylhexanoyl group, a 2-ethylhexanoyl group, a 2-methyl-2-pentenoyl group, a 2,2-dimethylpentenoyl group, a 2-octenoyl group, a citroneryl group, a undecylenoyl group, a myristoleyl group, a palmitoleyl group, an oleoyl group, an elaidyl group, an eicosenoyl group, an erucyl group, a nervonyl group, a 2,4-pentadienoyl group, a 2,4-hexadienoyl group, a 2,6-pentadienoyl group, a geranyl group, a linoleyl group, a 11,14-eicosadienoyl group, a linolenyl group, a 8,11,14-eicosatrienoyl group, an arachidonyl group, a 5,8,11,14,17-eicosapentaenoyl group, a 4,7,10,13,16,19-docosahexanoyl group, a cyclobutylacetyl group, a cyclopentanoyl group, a cyclopentylacetyl group, a cyclopentylpropionyl group, a cyclohexanoyl group, a cyclohexylacetyl group, a cyclohexylpropionyl group, a cyclohexylbutyryl group, a cyclohexylpentanoyl group, a dicyclohexylacetyl group, a 1-methyl-1-cyclohexanecarbonyl group, a 2-methyl-1-cyclohexanecarbonyl group, a 3-methyl-1-cyclohexanecarbonyl group, a 4-methyl-1-cyclohexanecarbonyl group, a 4-tert-butyl-1-cyclohexanecarbonyl group, a 4-pentyl-1-cyclohexanecarbonyl group, a 4-methyl-cyclohexaneacetyl group, a cycloheptayl group, a 2-norborneneacetyl group, a 4-pentylbicyclo[2,2,2]octane-1-carbonyl group, a 3-oxotricyclo[2,2,1,0(2,6)]-heptane-7-carbonyl group, a 3-noradamantanecarbonyl group, a 1-adamantanecarbonyl group, a 1-adamantaneacetyl group, a 1-cyclopentene-1-carbonyl group, a 1-cyclopentene-1-acetyl group, a 1-cyclohexene-1-carbonyl group, and a 1-methyl-2-cyclohexene-1-carbonyl group.

Among these, preferred are a pentanoyl group, a hexanoyl group, a heptanoyl group, an octanoyl group, a nonanoyl group, a decanoyl group, an undecanoyl group, a dodecanoyl group, a tridecanoyl group, a tetradecanoyl group, a pentatetradecanoyl group, a hexadecanoyl group, a heptadecanoyl group, an octadecanoyl group, a nonadecanoyl group, an eicosanoyl group, a heneicosanoyl group, a docosanoyl group, a trimethylacetyl group, a 2-methylbutyryl group, an isovaleryl group, a 2-ethylbutyryl group, a 2,2-dimethylbutyryl group, a tert-butylacetyl group, a 2-methylvaleryl group, a 3-methylvaleryl group, a 4-methylvaleryl group, a 2-propylpentanoyl group, a 2-ethylhexanoyl group, a citroneryl group, a undecylenoyl group, a myristoleyl group, a palmitoleyl group, an oleoyl group, an elaidyl group, an eicosenoyl group, an erucyl group, a nervonyl group, a 2,4-pentadienoyl group, a 2,4-hexadienoyl group, a 2,6-pentadienoyl group, a geranyl group, a linoleyl group, a cyclohexanoyl group, a cyclohexylacetyl group, a cyclohexylpropionyl group, a cyclohexylbutyryl group, a cyclohexylpentanoyl group, a dicyclohexylacetyl group, a 1-methyl-1-cyclohexanecarbonyl group, a 2-methyl-1-cyclohexanecarbonyl group, a 3-methyl-1-cyclohexanecarbonyl group, a 4-methyl-1-cyclohexanecarbonyl group, a 4-tert-butyl-1-cyclohexanecarbonyl group, a 4-pentyl-1-cyclohexanecarbonyl group, and a 4-methyl-cyclohexaneacetyl group.

More preferred are a hexanoyl group, an octanoyl group, a nonanoyl group, a decanoyl group, a dodecanoyl group, a hexadecanoyl group, an octadecanoyl group, a 2-ethylbutyryl group, a 2,2-dimethylbutyryl group, a tert-butylacetyl group, a 2-methylvaleryl group, a 3-methylvaleryl group, a 4-methylvaleryl group, a 2-ethylhexanoyl group, a palmitoleyl group, an oleoyl group, a cyclohexanoyl group, and a cyclohexylacetyl group.

Most preferred are a hexanoyl group, an octanoyl group, a 2-ethylhexanoyl group, a dodecanoyl group, an octadecanoyl group, and a cyclohexanoyl group.

### (Acyl Group Containing an Aromatic Group (B))

The acyl group containing an aromatic group (B) for use in the present invention may be bonded to the ester bond moiety directly or through a linking group. The linking group as used herein indicates an alkylene group, an alkenylene group or an alkynylene group, and the linking group may have a substituent. The linking group is preferably an alkylene, alkenylene or alkynylene group having a carbon number of 1 to 10, more preferably an alkylene or alkenylene group having a carbon number of 1 to 6, and most preferably an alkylene or alkenylene group having a carbon number of 1 to 4.

The aromatic group may have a substituent, and examples of the substituent substituted to the aromatic group and the substituent substituted to the linking group include an alkyl group (preferably having a carbon number of 1 to 20, more preferably from 1 to 12, still more preferably from 1 to 8, e.g., methyl, ethyl, propyl, isopropyl, tert-butyl, n-butyl, n-octyl, n-decyl, n-hexadecyl, cyclopropyl, cyclopentyl, cyclohexyl), an alkenyl group (preferably having a carbon number of 2 to 20, more preferably from 2 to 12, still more preferably from 2 to 8, e.g., vinyl, allyl, 2-butenyl, 3-pentenyl), an alkynyl group (preferably having a carbon number of 2 to 20, more preferably from 2 to 12, still more preferably from 2 to 8, e.g., propargyl, 3-pentynyl), an aryl group (preferably having a carbon number of 6 to 30, more preferably from 6 to 20, still more preferably from 6 to 12, e.g., phenyl, biphenyl, naphthyl), an amino group (preferably having a carbon number of 0 to 20, more preferably from 0 to 10, still more preferably from 0 to 6, e.g., amino, methylamino, dimethylamino, diethylamino, dibenzylamino), an alkoxy group (preferably having a carbon number of 1 to 20, more preferably from 1 to 12, still more preferably from 1 to 8, e.g., methoxy, ethoxy, butoxy), an aryloxy group (preferably having a carbon number of 6 to 20, more preferably from 6 to 16, still more preferably from 6 to 12, e.g., phenyloxy, 2-naphthyloxy), an acyl group (preferably having a carbon number of 1 to 20, more preferably 1 to 16, still more preferably 1 to 12, e.g., acetyl, benzoyl, formyl, pivaloyl), an alkoxycarbonyl group (preferably having a carbon number of 2 to 20, more preferably from 2 to 16, still more preferably from 2 to 12, e.g., methoxycarbonyl, ethoxycarbonyl), an aryloxycarbonyl group (preferably having a carbon number of 7 to 20, more preferably from 7 to 16, still more preferably from 7 to 10, e.g., phenyloxycarbonyl), an acyloxy group (preferably having a carbon number of 2 to 20, more preferably from 2 to 16, still more preferably from 2 to 10, e.g., acetoxy, benzoyloxy), an acylamino group (preferably having a carbon number of 2 to 20, more preferably from 2 to 16, still more preferably from 2 to 10, e.g., acetylamino, benzoylamino), an alkoxycarbonylamino group (preferably having a carbon number of 2 to 20, more preferably from 2 to 16, still more preferably from 2 to 12, e.g., methoxycarbonylamino), an aryloxycarbonylamino group (preferably having a carbon number of 7 to 20, more preferably from 7 to 16, still more preferably from 7 to 12, e.g., phenyloxycarbonylamino), a sulfonylamino group (preferably having a carbon number of 1 to 20, more preferably from 1 to 16, still more preferably from 1 to 12, e.g., methanesulfonylamino, benzenesulfonylamino), a sulfamoyl group (preferably having a carbon number of 0 to 20, more preferably from 0 to 16, still more preferably from 0 to 12, e.g., sulfamoyl, methylsulfamoyl, dimethylsulfamoyl, phenylsulfamoyl), a carbamoyl group (preferably having a carbon number of 1 to 20, more preferably from 1 to 16, still more preferably from 1 to 12, e.g., carbamoyl, methylcarbamoyl, diethylcarbamoyl, phenylcarbamoyl), an alkylthio group (preferably having a carbon number of 1 to 20, more preferably from 1 to 16, still more preferably from 1 to 12, e.g., methylthio, ethylthio), an arylthio group (preferably having a carbon number of 6 to 20, more preferably from 6 to 16, still more preferably from 6 to 12, e.g., phenylthio), a sulfonyl group (preferably having a carbon number of 1 to 20, more preferably from 1 to 16, still more preferably from 1 to 12, e.g., mesyl, tosyl), a sulfinyl group (preferably having a carbon number of 1 to 20, more preferably from 1 to 16, still more preferably from 1 to 12, e.g., methanesulfinyl, benzenesulfinyl), a ureido group (preferably having a carbon number of 1 to 20, more preferably from 1 to 16, still more preferably from 1 to 12, e.g., ureido, methylureido, phenylureido), a phosphoric acid amide group (preferably having a carbon number of 1 to 20, more preferably from 1 to 16, still more preferably from 1 to 12, e.g., diethylphosphoric acid amide, phenylphosphoric acid amide), a hydroxy group, a mercapto group, a halogen atom (e.g., fluorine, chlorine, bromine, iodine), a cyano group, a sulfo group, a carboxyl group, a nitro group, a hydroxamic acid group, a sulfino group, a hydrazino group, an imino group, a heterocyclic group (preferably having a carbon number of 1 to 30, more preferably from 1 to 12; the heteroatom is, for example, nitrogen atom, oxygen atom or sulfur atom; specifically, e.g., imidazolyl, pyridyl, quinolyl, furyl, piperidyl, morpholino, benzoxazolyl, benzimidazolyl, benzothiazolyl), and a silyl group (preferably having a carbon number of 3 to 40, more preferably from 3 to 30, still more preferably from 3 to 24, e.g., trimethylsilyl, triphenylsilyl). These substituents each may be further substituted. When two or more substituents are present, these substituents may be the same or different. Also, if possible, the substituents may combine with each other to form a ring.

The “aromatic” is defined as an aromatic compound in Rikagaku Jiten (Physics and Chemistry Dictionary), 4th ed., page 1208 (Iwanami Shoten), and the aromatic group for use in the present invention may be an aromatic hydrocarbon group or an aromatic heterocyclic group and is preferably an aromatic hydrocarbon group.

The aromatic hydrocarbon group is preferably an aromatic hydrocarbon group having a carbon number of 6 to 24, more preferably from 6 to 12, still more preferably from 6 to 10. Specific example of the aromatic hydrocarbon group include a phenyl group, a naphthyl group, an anthryl group, a biphenyl group, and a terphenyl group. The aromatic hydrocarbon group is preferably a phenyl group, a naphthyl group or a biphenyl group. The aromatic heterocyclic group is preferably an aromatic heterocyclic group containing at least one atom of an oxygen atom, a nitrogen atom and a sulfur atom. Specific examples of the hetero ring thereof include furan, pyrrole, thiophene, imidazole, pyrazole, pyridine, pyrazine, pyridazine, triazole, triazine, indole, indazole, purine, thiazoline, thiadiazole, oxazoline, oxazole, oxadiazole, quinoline, isoquinoline, phthalazine, naphthylidine, quinoxaline, quinazoline, cinnoline, pteridine, acridine, phenanthroline, phenazine, tetrazole, benzimidazole, benzoxazole, benzothiazole, benzotriazole and tetrazaindene. The aromatic heterocyclic group is preferably a pyridyl group, a triazinyl group or a quinolyl group.

Preferred examples of the acyl group containing an aromatic group (B) include a phenylacetyl group, a hydrocinnamoyl group, a diphenylacetyl group, a phenoxyacetyl group, a benzyloxyacetyl group, an O-acetylmandelyl group, a 3-methoxyphenylacetyl group, a 4-methoxyphenylacetyl group, a 2,5-dimethoxyphenylacetyl group, a 3,4-dimethoxyphenylacetyl group, a 9-fluorenylmethylacetyl group, a cinnamoyl group, a 4-methoxy-cinnamoyl group, a benzoyl group, an ortho-toluoyl group, a meta-toluoyl group, a para-toluoyl group, an m-anisoyl group, a p-anisoyl group, a phenylbenzoyl group, a 4-ethylbenzoyl group, a 4-propylbenzoyl group, a 4-tert-butylbenzoyl group, a 4-butylbenzoyl group, a 4-pentylbenzoyl group, a 4-hexylbenzoyl group, a 4-heptylbenzoyl group, a 4-octylbenzoyl group, a 4-vinylbenzoyl group, a 4-ethoxybenzoyl group, a 4-butoxybenzoyl group, a 4-hexyloxybenzoyl group, a 4-heptyloxybenzoyl group, a 4-pentyloxybenzoyl group, a 4-octyloxybenzoyl group, a 4-nonyloxybenzoyl group, a 4-decyloxybenzoyl group, a 4-undecyloxybenzoyl group, a 4-dodecyloxybenzoyl group, a 4-isopropioxybenzoyl group, a 2,3-dimethoxybenzoyl group, a 2,5-dimethoxybenzoyl group, a 3,4-dimethoxybenzoyl group, a 2,6-dimethoxybenzoyl group, a 2,4-dimethoxybenzoyl group, a 3,5-dimethoxybenzoyl group, a 3,4,5-trimethoxybenzoyl group, a 2,4,5-trimethoxybenzoyl group, a 1-naphthoyl group, a 2-naphthoyl group, a 2-biphenylcarbonyl group, a 4-biphenylcarbonyl group, a 4′-ethyl-4-biphenylcarbonyl group, a 4′-octyloxy-4-biphenylcarbonyl group, a piperonyloyl group, a diphenylacetyl group, a triphenylacetyl group, a phenylpropionyl group, a hydrocinnamoyl group, an α-methylhydrocinnamoyl group, a 2,2-diphenylpropionyl group, a 3,3-diphenylpropionyl group, a 3,3,3-triphenylpropionyl group, a 2-phenylbutyryl group, a 3-phenylbutyryl group, a 4-phenylbutyryl group, a 5-phenylvaleryl group, a 3-methyl-2-phenylvaleryl group, a 6-phenylhexanoyl group, an α-methoxyphenylacetyl group, a phenoxyacetyl group, a 3-phenoxypropionyl group, a 2-phenoxypropionyl group, a 11-phenoxydecanoyl group, a 2-phenoxybutyryl group, a 2-methoxyacetyl group, a 3-(2-methoxyphenyl)propionyl group, a 3-(p-toluoyl)propionyl group, a (4-methylphenoxy)acetyl group, a 4-isobutyl-α-methylphenylacetyl group, a 4-(4-methoxyphenyl)butyryl group, (2,4-di-tert-pentylphenoxy)-acetyl group, a 4-(2,4-di-tert-pentylphenoxy)-butyryl group, a (3,4-dimethoxyphenyl)acetyl group, a 3,4-(methylenedioxy)phenylacetyl group, a 3-(3,4-dimethoxyphenyl)propionyl group, a 4-(3,4-dimethoxyphenyl)butyryl group, (2,5-dimethoxyphenyl)acetyl group, a (3,5-dimethoxyphenyl)acetyl group, a 3,4,5-trimethoxyphenylacetyl group, a 3-(3,4,5-trimethoxyphenyl)-propionyl group, an acetyl group, a 1-naphthylacetyl group, a 2-naphthylacetyl group, an α-trityl-2-naphthalene-propionyl group, a (1-naphthoxy)acetyl group, a (2-naphthoxy)acetyl group, a 6-methoxy-α-methyl-2-naphthaleneacetyl group, a 9-fluoreneacetyl group, a 1-pyreneacetyl group, a 1-pyrenebutyryl group, a γ-oxo-pyrenebutyryl group, a styreneacetyl group, an α-methylcinnamoyl group, an α-phenylcinnamoyl group, a 2-methylcinnamoyl group, a 2-methoxycinnamoyl group, a 3-methoxycinnamoyl group, a 2,3-dimethoxycinnamoyl group, a 2,4-dimethoxycinnamoyl group, a 2,5-dimethoxycinnamoyl group, a 3,4-dimethoxycinnamoyl group, a 3,5-dimethoxycinnamoyl group, a 3,4-(methylenedioxy)cinnamoyl group, a 3,4,5-trimethoxycinnamoyl group, a 2,4,5-trimethoxycinnamoyl group, a 3-methylidene-2-carbonyl group, a 4-(2-cyclohexyloxy)benzoyl group, a 2,3-dimethylbenzoyl group, a 2,6-dimethylbenzoyl group, a 2,4-dimethylbenzoyl group, a 2,5-dimethylbenzoyl group, a 3-methoxy-4-methylbenzoyl group, a 3,4-diethoxybenzoyl group, an α-phenyl-O-toluoyl group, a 2-phenoxybenzoyl group, a 2-benzoylbenzoyl group, a 3-benzoylbenzoyl group, a 4-benzoylbenzoyl group, a 2-ethoxy-1-naphthoyl group, a 9-fluorenecarbonyl group, a 1-fluorenecarbonyl group, a 4-fluorenecarbonyl group, a 9-anthracenecarbonyl group, and a 1-pyrenecarbonyl group.

Among these, more preferred are a phenylacetyl group, a hydrocinnamoyl group, a diphenylacetyl group, a phenoxyacetyl group, a benzyloxyacetyl group, an O-acetylmandelyl group, a 3-methoxyphenylacetyl group, a 4-methoxyphenylacetyl group, a 2,5-dimethoxyphenylacetyl group, a 3,4-dimethoxyphenylacetyl group, a 9-fluorenylmethylacetyl group, a cinnamoyl group, a 4-methoxy-cinnamoyl group, a benzoyl group, an ortho-toluoyl group, a meta-toluoyl group, a para-toluoyl group, an m-anisoyl group, a p-anisoyl group, a phenylbenzoyl group, a 4-ethylbenzoyl group, a 4-propylbenzoyl group, a 4-tert-butylbenzoyl group, a 4-butylbenzoyl group, a 4-pentylbenzoyl group, a 4-hexylbenzoyl group, a 4-heptylbenzoyl group, a 4-octylbenzoyl group, a 4-vinylbenzoyl group, a 4-ethoxybenzoyl group, a 4-butoxybenzoyl group, a 4-hexyloxybenzoyl group, a 4-heptyloxybenzoyl group, a 4-pentyloxybenzoyl group, a 4-octyloxybenzoyl group, a 4-nonyloxybenzoyl group, a 4-decyloxybenzoyl group, a 4-undecyloxybenzoyl group, a 4-dodecyloxybenzoyl group, a 4-isopropioxybenzoyl group, a 2,3-dimethoxybenzoyl group, a 2,5-dimethoxybenzoyl group, a 3,4-dimethoxybenzoyl group, a 2,6-dimethoxybenzoyl group, a 2,4-dimethoxybenzoyl group, a 3,5-dimethoxybenzoyl group, a 2,4,5-trimethoxybenzoyl group, a 3,4,5-trimethoxybenzoyl group, a 1-naphthoyl group, a 2-naphthoyl group, a 2-biphenylcarbonyl group, a 4-biphenylcarbonyl group, a 4′-ethyl-4-biphenylcarbonyl group, and a 4′-octyloxy-4-biphenylcarbonyl group.

Still more preferred are a phenylacetyl group, a diphenylacetyl group, a phenoxyacetyl group, a cinnamoyl group, a 4-methoxy-cinnamoyl group, a benzoyl group, a phenylbenzoyl group, a 4-ethylbenzoyl group, a 4-propylbenzoyl group, a 4-tert-butylbenzoyl group, a 4-butylbenzoyl group, a 4-pentylbenzoyl group, a 4-hexylbenzoyl group, a 4-heptylbenzoyl group, a 3,4-dimethoxybenzoyl group, a 2,6-dimethoxybenzoyl group, a 2,4-dimethoxybenzoyl group, a 3,5-dimethoxybenzoyl group, a 3,4,5-trimethoxybenzoyl group, a 2,4,5-trimethoxybenzoyl group, a 1-naphthoyl group, a 2-naphthoyl group, a 2-biphenylcarbonyl group, and a 4-biphenylcarbonyl group.

Most preferred are a benzoyl group, a phenylbenzoyl group, and a 4-heptylbenzoyl group.

In addition to the acyl group (A) and the acyl group (B), the cellulose compound for use in the present invention preferably further contains (C) an aliphatic acyl group having a carbon number of 2 to 4. Specific examples of the aliphatic acyl group (C) having a carbon number of 2 to 4 include an acetyl group, a propionyl group, a butyryl group and an isobutyryl group. Among these, an acetyl group, a propionyl group and a butyryl group are preferred, and an acetyl group is more preferred.

The cellulose compound for use in the present invention preferably satisfies the following formula (I):

2.4≦DSA+DSB+DSC≦3.0 Formula (I)

wherein DSA, DSB and DSC represent the substitution degrees of the acyl group (A), the acyl group (B) and the acyl group (C), respectively. The β-1,4-bonded glucose unit constituting the cellulose has a free hydroxyl group at the 2-, 3- and 6-positions. In the present invention, the substitution degree indicates a ratio at which any one of the hydroxyl groups at the 2-, 3- and 6-positions is substituted by a specific substituent. When the hydroxyl groups at the 2-, 3- and 6-positions all are substituted by a substituent, the substitution degree becomes 3.0. Furthermore, in the present invention, DSA+DSB+DSC represents a total substitution degree and indicates substitution degrees of all substituents substituted to the hydroxyl groups at the 2-, 3- and 6-positions. In the present invention, the substitution degree of the substituent and the substitution degree distribution can be determined from ¹H-NMR or ¹³C-NMR by using the methods described in Cellulose Communication 6, 73-79 (1999) and Chrality, 12(9),670-674.

The cellulose compound for use in the present invention preferably satisfies the following formula (Ia) and most preferably satisfies formula (Ib):

2.6≦DSA+DSB+DSC≦3.0 Formula (Ia)

2.7≦DSA+DSB+DSC≦3.0 Formula (Ib):

By setting the total substitution degree DSA+DSB+DSC of the cellulose compound to the above-described range, the humidity dependency of Re and Rth of the cellulose acylate film obtained from the composition containing the cellulose compound can be enhanced.

The cellulose compound for use in the present invention preferably satisfies the following formula (II):

0.1<DSA<0.8 Formula (II)

wherein DSA represents the substitution degree of the acyl group (A).

The cellulose compound for use in the present invention preferably satisfies the following formula (IIa) and most preferably satisfies formula (IIb):

0.15<DSA<0.8 Formula (IIa)

0.2<DSA<0.7 Formula (IIb)

By setting DSA to the above-described range, the humidity dependency of Re and Rth can be reduced and this is preferred.

The cellulose compound for use in the present invention preferably satisfies the following formula (III):

0.1<DSB<0.8 Formula (III)

In formula (III), DSB represents the substitution degree of the acyl group (B).

The cellulose compound for use in the present invention preferably satisfies the following formula (IIIa) and most preferably satisfies formula (IIIb):

0.2<DSB<0.8 Formula (IIIa)

0.25<DSB<0.5 Formula (IIIb)

By setting DSB to the above-described range, retardation having a large absolute value can be developed and this is preferred.

The cellulose compound for use in the present invention preferably satisfies the following formula (IV) or (IV-I):

0.7DSB≦DSB₆ Formula (IV)

DSB₆≦0.3DSB Formula (IV-I)

(wherein DSB represents the substitution degree of the acyl group (B) and DSB₆ represents the substitution degree of the acyl group (B) at the 6-position).

When formula (IV) is satisfied, Rth takes a positive value, and when formula (IV-I) is satisfied, Rth takes a negative value.

The cellulose compound for use in the present invention preferably satisfies the following formula (IVa) or (IVa-I) and most preferably satisfies the following formula (IVb) or (IVb-I):

0.75DSB≦DSB₆ Formula (IVa)

0.8DSB≦DSB₆ Formula (IVa-I)

DSB₆≦0.25DSB Formula (IVb)

DSB₆≦0.2DSB Formula (IVb-I)

By setting DSB₆ to the above-described range, the absolute values of Re and Rth can be made large and this is preferred.

Particularly preferred examples of the cellulose compound for use in the present invention are shown in Table 1, but the present invention is not limited to these specific examples. In Table 1, DSB₆ indicates the substitution degree of the substituent substituted at the 6-position out of the substitution degrees of the acyl group containing an aromatic group B.

TABLE 1

| | | | | | | | Total |
|---|---|---|---|---|---|---|---|
| | | | | DSB | | | Substitution |
| No | Substituent A | DSA | Substituent B | (DSB₆) | Substituent C | DSC | Degree |
| A-1 | hexanoyl group | 0.26 | benzoyl group | 0.30 | acetyl group | 2.44 | 3.0 |
| | | | | (0.27) | | | |
| A-2 | hexanoyl group | 0.26 | phenylbenzoyl | 0.30 | acetyl group | 2.44 | 3.0 |
| | | | group | (0.27) | | | |
| A-3 | hexanoyl group | 0.75 | benzoyl group | 0.1 | acetyl group | 2.15 | 3.0 |
| | | | | (0.1) | | | |
| A-4 | hexanoyl group | 0.38 | benzoyl group | 0.35 | acetyl group | 2.15 | 2.88 |
| | | | | (0.30) | | | |
| A-5 | hexanoyl group | 0.50 | phenylbenzoyl | 0.35 | acetyl group | 2.15 | 3.0 |
| | | | group | (0.30) | | | |
| A-6 | hexanoyl group | 0.53 | asaronyl group | 0.32 | acetyl group | 2.15 | 3.0 |
| | | | | (0.30) | | | |
| A-7 | 2-ethylhexanoyl | 0.35 | benzoyl group | 0.35 | acetyl group | 2.15 | 2.85 |
| | group | | | (0.30) | | | |
| A-8 | 2-ethylhexanoyl | 0.5 | phenylbenzoyl | 0.35 | acetyl group | 2.15 | 3.0 |
| | group | | group | (0.35) | | | |
| A-9 | 2-ethylhexanoyl | 0.3 | benzoyl group | 0.42 | acetyl group | 2.15 | 2.87 |
| | group | | | (0.35) | | | |
| A-10 | 2-ethylhexanoyl | 0.35 | benzoyl group | 0.30 | acetyl group | 2.15 | 2.80 |
| | group | | | (0.04) | | | |
| A-11 | 2-ethylhexanoyl | 0.5 | phenylbenzoyl | 0.35 | acetyl group | 2.15 | 3.0 |
| | group | | group | (0.04) | | | |
| A-12 | 2-ethylhexanoyl | 0.5 | asaronyl group | 0.35 | acetyl group | 2.15 | 3.0 |
| | group | | | (0.04) | | | |
| A-13 | octanoyl group | 0.35 | benzoyl group | 0.30 | acetyl group | 2.15 | 2.80 |
| | | | | (0.04) | | | |
| A-14 | octanoyl group | 0.30 | benzoyl group | 0.42 | acetyl group | 2.15 | 2.87 |
| | | | | (0.35) | | | |
| A-15 | octanoyl group | 2.9 | benzoyl group | 0.1 | — | — | 3.0 |
| | | | | (0.10) | | | |
| A-16 | hexanoyl group | 2.9 | benzoyl group | 0.1 | — | — | 3.0 |
| | | | | (0.10) | | | |
| A-17 | dodecanoyl group | 0.30 | benzoyl group | 0.26 | acetyl group | 2.44 | 3.0 |
| | | | | (0.02) | | | |
| A-18 | dodecanoyl group | 0.35 | benzoyl group | 0.30 | acetyl group | 2.15 | 2.80 |
| | | | | (0.04) | | | |
| A-19 | dodecanoyl group | 0.15 | benzoyl group | 0.45 | acetyl group | 2.15 | 2.75 |
| | | | | (0.03) | | | |
| A-20 | dodecanoyl group | 0.30 | benzoyl group | 0.42 | acetyl group | 2.15 | 2.87 |
| | | | | (0.35) | | | |
| A-21 | dodecanoyl group | 0.44 | benzoyl group | 0.41 | acetyl group | 2.15 | 3.0 |
| | | | | (0.35) | | | |
| A-22 | dodecanoyl group | 0.25 | benzoyl group | 0.30 | acetyl group | 2.15 | 2.7 |
| | | | | (0.30) | | | |
| A-23 | dodecanoyl group | 0.2 | benzoyl group | 0.30 | acetyl group | 2.15 | 2.65 |
| | | | | (0.30) | | | |
| A-24 | dodecanoyl group | 0.1 | benzoyl group | 0.30 | acetyl group | 2.15 | 2.55 |
| | | | | (0.30) | | | |
| A-25 | dodecanoyl | 0.21 | benzoyl group | 0.1 | acetyl group | 2.68 | 2.99 |
| | group | | | | propionyl | | |
| | | | | | group | | |
| A-26 | dodecanoyl | 0.20 | benzoyl group | 0.1 | acetyl group | 2.69 | 2.99 |
| | group | | | | butyryl group | | |
| A-27 | dodecanoyl | 0.25 | phenyl | 0.45 | acetyl group | 2.15 | 2.85 |
| | group | | benzoyl group | (0.35) | | | |
| A-28 | dodecanoyl | 0.25 | cinnamoyl | 0.45 | acetyl group | 2.15 | 2.85 |
| | group | | group | (0.35) | | | |
| A-29 | dodecanoyl | 0.25 | 4-methoxy- | 0.45 | acetyl group | 2.15 | 2.85 |
| | group | | cinnamoyl | (0.35) | | | |
| | | | group | | | | |
| A-30 | dodecanoyl | 0.25 | biphenylacetyl | 0.45 | acetyl group | 2.15 | 2.85 |
| | group | | group | (0.35) | | | |
| A-31 | dodecanoyl | 0.35 | 2.5-dimethoxy | 0.30 | acetyl group | 2.15 | 2.80 |
| | group | | benzoyl group | (0.04) | | | |
| A-32 | dodecanoyl | 0.35 | asaronyl group | 0.30 | acetyl group | 2.15 | 2.80 |
| | group | | | (0.04) | | | |
| A-33 | dodecanoyl | 0.35 | 4-heptyl- | 0.30 | acetyl group | 2.15 | 2.80 |
| | group | | benzoyl group | (0.04) | | | |
| A-34 | octadecanoyl | 0.28 | benzoyl group | 0.28 | acetyl group | 2.44 | 3.0 |
| | group | | | (0.07) | | | |
| A-35 | octadecanoyl | 0.35 | benzoyl group | 0.30 | acetyl group | 2.15 | 2.80 |
| | group | | | (0.04) | | | |
| A-36 | octadecanoyl | 0.15 | benzoyl group | 0.40 | acetyl group | 2.15 | 2.70 |
| | group | | | (0.35) | | | |
| A-37 | octadecanoyl | 0.3 | benzoyl group | 0.42 | acetyl group | 2.15 | 2.87 |
| | group | | | (0.35) | | | |
| A-38 | cyclohexanoyl | 0.38 | benzoyl group | 0.35 | acetyl group | 2.15 | 2.88 |
| | group | | | (0) | | | |
| A-39 | cyclohexanoyl | 0.50 | benzoyl group | 0.35 | acetyl group | 2.15 | 3.00 |
| | group | | | (0) | | | |
| A-40 | cyclohexanoyl | 0.28 | benzoyl group | 0.28 | acetyl group | 2.44 | 3.00 |
| | group | | | (0.07) | | | |
| A-41 | dodecanoyl | 0.35 | benzoyl group | 0.50 | acetyl group | 2.15 | 3.0 |
| | group | | | (0) | | | |

In the present invention, the cellulose compound indicates a compound having a cellulose skeleton obtained by using a cellulose as a raw material and biologically or chemically introducing a functional group and is preferably cellulose acylate.

As for the raw material cotton of the cellulose acylate used in the present invention, a cellulose having a low polymerization degree (polymerization degree: from 100 to 300) obtained by acid-hydrolyzing wood pulp, such as fine crystal cellulose, as well as natural cellulose such as cotton linter and wood pulp (e.g., hardwood pulp, softwood pulp) can be used, and a mixture thereof may be used depending on the case. These raw material celluloses are described in detail, for example, in Marusawa and Uda, Plastic Zairyo Koza (17), Seniso-kei Jushi (Lecture on Plastic Material (17), Fiber-Based Resin), Nikkan Kogyo Shinbun Sha (1970), JIII Journal of Technical Disclosure, No. 2001-1745, pp. 7-8, and Cellulose no Jiten (Encyclopedia of Cellulose), page 523, compiled by The Cellulose Society of Japan, Asakura-Shoten (2000), and celluloses described therein can be used. The cellulose is not particularly limited.

The viscosity average polymerization degree of the cellulose acylate is preferably from 140 to 700, more preferably from 150 to 500, and most preferably from 180 to 500. When the average polymerization degree is 500 or less, the viscosity of the dope solution of cellulose compound does not become excessively high and film production by casting tends to be facilitated. Also, when the polymerization degree is 140 or more, the strength of the film produced tends to be more increased and this is preferred. The average polymerization degree can be measured according to the intrinsic viscosity method proposed by Uda, et al. (Kazuo Uda and Hideo Saito, Journal of the Society of Fiber Science and Technology, Japan, Vol. 18, No. 1, pp. 105-120 (1962)). Specifically, the average polymerization degree can be measured according to the method described in JP-A-9-95538.

The cellulose compound for use in the present invention can be obtained by using cellulose acetate produced by Aldrich (acetyl substitution degree: 2.45) or cellulose acetate produced by Daicel Chemical Industries, Ltd. (acetyl substitution degree: 2.41 (trade name: L-70), 2.15 (trade name: FL-70), 1.70 (trade name) LL-10)) as a starting material and reacting it with a corresponding acid chloride.

The position of the acyl group is controlled, for example, by reacting cellulose acetate with a predetermined amount of acid chloride intended to introduce into the 6-position in an acetone solvent in the presence of a predetermined amount of a base, and then with acid chloride intended to introduce into the 2- and 3-positions.

### [Cellulose Compound Composition]

The cellulose compound composition of the present invention is described below.

The cellulose compound composition of the present invention comprises a cellulose compound containing (A) an aliphatic acyl group having a carbon number of 5 to 30 and (B) an acyl group containing an aromatic group.

The cellulose compound composition of the present invention preferably contains a cellulose compound in an amount of 70 wt % or more, more preferably 80 wt % or more, and most preferably 90 wt % or more, based on the entire composition.

The cellulose compound composition of the present invention can take various shapes such as grain, powder, fiber, lump, solution, melt and film.

In terms of the raw material for the film production, the shape is preferably grain or powder. Therefore, the cellulose acylate composition after drying may be pulverized or sieved to make uniform the particle size or improve the handleability.

In the present invention, only one kind of a cellulose compound may be used, or two or more kinds of cellulose compounds may be mixed and used. Also, a polymer component other than a cellulose compound, or various additives may be appropriately mixed. The component mixed is preferably a component having excellent compatibility with the cellulose compound and is preferably added such that the film formed has a transmittance of 80% or more, more preferably 90% or more, still more preferably 92% or more.

In the present invention, various additives (for example, an ultraviolet absorbent, a plasticizer, a deterioration inhibitor, a fine particle and an optical property adjusting agent) which can be generally added to cellulose acid may be added to the cellulose compound to prepare a composition. As for the timing of adding the additives to the cellulose compound represented by formula (I), the additives may be added at any time in the dope production step or may be added at the end in the process of preparing the dope.

### [Cellulose Compound Film]

The present invention also relates to a cellulose compound film.

The cellulose compound film of the present invention is a cellulose compound film formed from the cellulose composition of the present invention.

In the cellulose compound film of the present invention, the cellulose compound of the present invention is preferably contained in an amount of 50 wt % or more, more preferably 80 wt % or more, and most preferably 95 wt % or more.

The production method of the cellulose compound film of the present invention is not particularly limited, but the cellulose compound film is preferably produced by the following melt film-forming method or solution film-forming method.

### <Solution Film-Formation>

The preferred embodiment in producing the cellulose compound film of the present invention by the solution film-forming method is described below.

In the present invention, the solvent for the cellulose compound is not particularly limited as long as the cellulose compound can be dissolved, cast and film-formed. The preferred solvent includes a chlorine-based organic solvent such as dichloromethane, chloroform, 1,2-dichloroethane and tetrachloroethylene, and a chlorine-free organic solvent.

The chlorine-free organic solvent for use in the present invention is preferably a solvent selected from an ester, a ketone and an ether each having a carbon number of 3 to 12. The ester, the ketone, and the ether may have a cyclic structure. A compound having two or more functional groups of an ester, a ketone and an ether (that is, —O—, —CO— and —COO—) may also be used as the main solvent, and the compound may have another functional group such as alcoholic hydroxyl group. In the case of a main solvent having two or more kinds of functional groups, the number of carbon atoms may suffice if it falls within the range specified for the compound having any one functional group. Examples of the esters having a carbon number of 3 to 12 include ethyl formate, propyl formate, pentyl formate, methyl acetate, ethyl acetate and pentyl acetate. Examples of the ketones having a carbon number of 3 to 12 include acetone, methyl ethyl ketone, diethyl ketone, diisobutyl ketone, cyclopentanone, cyclohexanone and methylcyclohexanone. Examples of the ethers having a carbon number of 3 to 12 include diisopropyl ether, dimethoxymethane, dimethoxyethane, 1,4-dioxane, 1,3-dioxolane, tetrahydrofuran, anisole and phenetole. Examples of the organic solvent having two or more kinds of functional groups include 2-ethoxyethyl acetate, 2-methoxyethanol and 2-butoxyethanol.

The chlorine-based organic solvent for use in the present invention is not particularly limited as long as its purpose can be achieved and the cellulose compound can be dissolved, cast and film-formed. The chlorine-based organic solvent is preferably dichloromethane or chloroform, more preferably dichloromethane. An organic solvent other than a chlorine-based organic solvent may also be mixed without any particular problem. In this case, dichloromethane needs to be used to a concentration of at least 50 mass %. The chlorine-free organic solvent used in combination in the present invention is described below. The chlorine-free organic solvent is preferably a solvent selected from an ester, a ketone, an ether, an alcohol, a hydrocarbon and the like each having a carbon number of 3 to 12. The ester, ketone, ether and alcohol each may have a cyclic structure. A compound having two or more functional groups of an ester, a ketone and an ether (that is, —O—, —CO— and —COO—) may also be used as the solvent, and the compound may have another functional group such as alcoholic hydroxyl group at the same time. In the case of a solvent having two or more kinds of functional groups, the number of carbon atoms may suffice if it falls within the range specified for the compound having any one functional group. Examples of the esters having a carbon number of 3 to 12 include ethyl formate, propyl formate, pentyl formate, methyl acetate, ethyl acetate and pentyl acetate. Examples of the ketones having a carbon number of 3 to 12 include acetone, methyl ethyl ketone, diethyl ketone, diisobutyl ketone, cyclopentanone, cyclohexanone and methylcyclohexanone. Examples of the ethers having a carbon number of 3 to 12 include diisopropyl ether, dimethoxymethane, dimethoxyethane, 1,4-dioxane, 1,3-dioxolane, tetrahydrofuran, anisole and phenetole. Examples of the organic solvent having two or more kinds of functional groups include 2-ethoxyethyl acetate, 2-methoxyethanol and 2-butoxyethanol.

The alcohol preferably used in combination with the chlorine-based organic solvent may be linear, branched or cyclic. In particular, a saturated aliphatic hydrocarbon is preferred. The hydroxyl group of the alcohol may be primary, secondary or tertiary. Examples of the alcohol include methanol, ethanol, 1-propanol, 2-propanol, 1-butanol, 2-butanol, tert-butanol, 1-pentanol, 2-methyl-2-butanol and cyclohexanol. A fluorine-based alcohol may also be used as the alcohol. Examples thereof include 2-fluoroethanol, 2,2,2-trifluoroethanol and 2,2,3,3-tetra-fluoro-1-propanol. The hydrocarbon may be linear, branched or cyclic, and either an aromatic hydrocarbon or an aliphatic hydrocarbon can be used. The aliphatic hydrocarbon may be saturated or unsaturated. Examples of the hydrocarbon include cyclohexane, hexane, benzene, toluene and xylene.

The chlorine-free organic solvent used in combination with the chlorine-based organic solvent which is the main solvent for the cellulose compound is not particularly limited but is selected from methyl acetate, ethyl acetate, methyl formate, ethyl formate, acetone, dioxolane, dioxane, ketones having a carbon number of 4 to 7, acetoacetic acid esters, alcohols having a carbon number of 1 to 10, and a hydrocarbon. The chlorine-free organic solvent preferably used in combination includes methyl acetate, acetone, methyl formate, ethyl formate, methyl ethyl ketone, cyclopentanone, cyclohexanone, methyl acetylacetate, methanol, ethanol, 1-propanol, 2-propanol, 1-butanol, 2-butanol, cyclohexanol, cyclohexane and hexane.

In the present invention, the cellulose compound is preferably dissolved in an organic solvent to a concentration of 10 to 35 mass %, more preferably from 13 to 30 mass %, and a cellulose acylate solution where the cellulose compound is dissolved to a concentration of 15 to 28 mass % is still more preferred. For dissolving the cellulose compound to such a concentration, the cellulose compound may be dissolved to a predetermined concentration at the stage of dissolving the compound, or after previously preparing a solution in a low concentration (for example, from 9 to 14 mass %), a solution in a predetermined high concentration may be prepared at the concentration step which is described later. Also, after previously preparing a cellulose in a high concentration, a cellulose compound solution in a predetermined low concentration may be produced by adding various additives. There is no particular problem if the cellulose compound solution is adjusted to the concentration of the present invention by any of these methods

In the present invention, as for the preparation of the cellulose compound solution (dope), the method for dissolving the cellulose compound is not particularly limited, and the dissolution may be performed at room temperature or by a cooling dissolution method, a high-temperature dissolution method or a combination thereof. With respect to these methods, the preparation method of a cellulose acylate solution is described, for example, in JP-A-5-163301, JP-A-61-106628, JP-A-58-127737, JP-A-9-95544, JP-A-10-95854, JP-A-10-45950, JP-A-2000-53784, JP-A-11-322946, JP-A-11-322947, JP-A-2-276830, JP-A-2000-273239, JP-A-11-71463, JP-A-04-259511, JP-A-2000-273184, JP-A-11-323017 and JP-A-11-302388. The methods for dissolving cellulose acylate in an organic solvent described in these patent publications can be appropriately applied also in the present invention as long as it is within the scope of the present invention. In particular, as for the chlorine-free solvent system, the dissolution is performed by the method described in detail in JIII Journal of Technical Disclosure, No. 2001-1745, pp. 22-25, Japan Institute of Invention and Innovation (Mar. 15, 2001). Furthermore, the cellulose compound solution of the present invention is usually subjected to concentration and filtration of the solution, and these are similarly described in detail in JIII Journal of Technical Disclosure, No. 2001-1745, page 25, Japan Institute of Invention and Innovation (Mar. 15, 2001). In the case of performing the dissolution at a high temperature, the temperature is most often higher than the boiling point of the organic solvent used and in such a case, the solvent is used under pressure.

In the present invention, the viscosity and dynamic storage modulus of the cellulose compound solution are preferably in certain ranges. A sample solution (1 mL) is measured using Steel Cone with a diameter of 4 cm/2′ in a rheometer (CLS 500) (both manufactured by TA Instruments). The measurement is performed under the conditions of oscillation step/temperature ramp by varying the temperature at 2° C./min in the range from 40° C. to −10° C., and the static non-Newton viscosity n*(Pa·s) at 40° C. and the storage modulus G′ (Pa) at −5° C. are determined. Incidentally, the measurement is started after previously keeping the sample solution at the measurement initiation temperature until the liquid temperature becomes constant. In the present invention, the dope preferably has a viscosity of 1 to 400 Pa·s at 40° C. and a dynamic storage modulus of 500 Pa or more at 15° C., more preferably a viscosity of 10 to 200 Pa·s at 40° C. and a dynamic storage modulus of 100 to 1,000,000 Pa at 15° C. Furthermore, the dynamic storage modulus at low temperature is preferably larger and, for example, when the casting support is at −5° C., the dynamic storage modulus at −5° C. is preferably from 10,000 to 1,000,000 Pa, and when the support is at −50° C., the dynamic storage modulus at −50° C. is preferably from 10,000 to 5,000,000 Pa.

### (Specific Method of Solution Film-Formation)

The production method of the cellulose compound film of the present invention is described below. As regards the method and apparatus for producing the cellulose acylate film of the present invention, a solution casting film-forming method and a solution casting film-forming apparatus conventionally used for the production of a cellulose acylate film are used. The dope (cellulose compound solution) prepared in a dissolving machine (kettle) is once stored in a storing kettle and finalized by removing bubbles contained in the dope. The dope is fed to a pressure-type die from the dope discharge port through, for example, a pressure-type quantitative gear pump capable of feeding a constant amount of liquid with high precision by the number of rotations and uniformly cast on an endlessly running metal support in the casting part from a mouth ring (slit) of the pressure-type die, and the damp-dry dope film (sometimes called web) is peeled off from the metal support at the peeling point after traveling nearly one round of the metal support. The obtained web is nipped with clips at both ends and dried through conveyance by a tenter while keeping the width. Subsequently, the film is conveyed by a roll group of a drying apparatus to complete the drying and then taken up in a predetermined length by a take-up machine. The combination of the tenter and the drying apparatus comprising a roll group varies depending on the purpose. In the solution casting film-forming method used for the silver halide photographic light-sensitive material or the functional protective film for electronic display, a coating apparatus is often added for applying surface processing to the film, such as subbing layer, antistatic layer, antihalation layer and protective layer, in addition to the solution casting film-forming apparatus. These production steps are described in detail in JIII Journal of Technical Disclosure, No. 2001-1745, pp. 25-30, Japan Institute of Invention and Innovation (Mar. 15, 2001) with categories of casting (including co-casting), metal support, drying, separation, stretching and the like.

### <Treatment of Cellulose Compound Film>

### (Stretching)

The cellulose compound film of the present invention produced in this way by a melt film-forming method or a solution film-forming method is preferably stretched for the purpose of enhancing the surface state, developing Re and Rth, or improving the linear expansion coefficient.

The stretching may be performed on-line in the film-forming step, or after the completion of film formation, the film may be once taken up and then stretched off-line. That is, in the case of melt film-formation, the stretching may be performed while cooling in the film formation is not completed, or may be performed after the completion of cooling.

The stretching is preferably performed at a temperature of from Tg to (Tg+50° C.), more preferably from Tg to (Tg+40° C.), still more preferably from Tg to (Tg+30° C.). The stretch ratio if preferably from 0.1 to 500%, more preferably from 10 to 300%, still more preferably from 30 to 200%. The stretching may be performed either in one stage or in multiple stages. The stretch ratio as used herein is determined according to the following formula:

Stretch ratio (%)=100×{(length after stretching)−(length before stretching)}/length before stretching

Such stretching is performed by longitudinal stretching, transverse stretching, or a combination thereof. In the longitudinal stretching, for example, (1) roll stretching (where stretching in the longitudinal direction is performed by using two or more pairs of nip rolls set to a higher peripheral speed on the outlet side), and (2) fixed-edge stretching (where stretching in the longitudinal direction is performed by grasping both edges of film and conveying the film while gradually increasing the speed to the longitudinal direction), may be used. Also, in the transverse, for example, tenter stretching (where stretching is performed by grasping both edges of film with a chuck and expanding the film in the transverse direction (in the direction perpendicular to the longitudinal direction)) may be used. The longitudinal stretching or transverse stretching may be performed alone (uniaxial stretching), or these may be performed in combination (biaxial stretching). In the case of biaxial stretching, the longitudinal stretching and transverse stretching may be performed sequentially (sequential stretching) or at the same time (simultaneous stretching).

The stretching speed at the longitudinal stretching and transverse stretching is preferably from 10 to 10,000%/min, more preferably from 20 to 1,000%/min, still more preferably from 30 to 800%/min, In the case of multistage stretching, the stretching speed indicates the average value of stretching speeds at respective stages.

Subsequently to such stretching, relaxing of 0 to 10% in the longitudinal or transverse direction may also be preferably performed. Furthermore, subsequently to the stretching, heat setting may also be preferably performed at a temperature of 150 to 250° C. for 1 second to 3 minutes.

The film thickness after such stretching is preferably from 10 to 300 μm, more preferably from 20 to 200 μm, still more preferably from 30 to 100 μm.

The angle θ created by the film-forming direction (longitudinal direction) and the slow axis of Re of the film is preferably closer to 0°, +90° or −90°. That is, in the case of longitudinal stretching, the angle is preferably closer to 0°, more preferably 0±3°, still more preferably 0±2°, yet still more preferably 0±1°. In the case of transverse stretching, the angle is preferably 90±30° or −90±3°, more preferably 90±2° or −90±2°, still more preferably 90±1° or −90±1°.

In order to suppress light leakage which occurs when the polarizing plate is obliquely viewed, the transmission axis of the polarizing film and the in-plane slow axis of the cellulose compound film need to be arranged in parallel. The transmission axis of a roll film-shaped polarizing film continuously produced is generally parallel to the width direction of the roll film and therefore, for continuously laminating the roll film-shaped polarizing film and a protective film comprising a roll film-shaped cellulose compound film, the in-plane slow axis of the roll film-shaped protective film needs to be parallel to the width direction of the film. Accordingly, the stretching is preferably performed at a larger ratio in the width direction. The stretching may be performed on the way of the film-formation process, or a stock film produced and taken up may be stretched. In the former case, the film may be stretched in the state of containing a residual solvent and can be preferably stretched when the residual solvent amount is from 2 to 30 mass %.

The thickness of the cellulose compound film obtained after drying, which is preferably used the present invention, varies depending on the intended use but is preferably from 5 to 500 μm, more preferably from 20 to 300 μm, still more preferably from 30 to 150 μm. In the case of optical use, particularly, use for a VA liquid crystal display device, the film thickness is preferably from 40 to 110 μm. The film thickness may be adjusted to a desired thickness by controlling, for example, the concentration of solid contents contained in the dope, the slit gap of die mouth ring, the extrusion pressure from die, or the speed of metal support.

The width of the thus-obtained cellulose compound film is preferably from 0.5 to 3 m, more preferably from 0.6 to 2.5 m, still more preferably from 0.8 to 2.2 m. As for the length, the film is preferably taken up in a length of 100 to 10,000 m, more preferably from 500 to 7,000 m, still more preferably from 1,000 to 6,000 m, per roll. At the time of taking up the film, knurling is preferably provided to at least one edge. The width of the knurl is preferably from 3 to 50 mm, more preferably from 5 to 30 mm, and the height is preferably from 0.5 to 500 μm, more preferably from 1 to 200 μm. The knurling may be provided by either one-sided pressing or double-sided pressing.

The above-described unstretched or stretched cellulose compound film may be used by itself, may be used in combination with a polarizing plate, or may be used after providing thereon a liquid crystal layer, a layer having controlled refractive index (low reflection layer), or a hardcoat layer.

### [Optical Properties of Cellulose Compound Film]

In the context of the present invention, Re(λ) and Rth(λ) indicate the in-plane retardation and the retardation in the thickness direction, respectively, at a wavelength of λ. Re(λ) is measured by making light at a wavelength of λnm to be incident to the film normal direction in KOBRA 21ADH or WR (manufactured by Oji Scientific Instruments).

In the case where the film measured is a film expressed by a uniaxial or biaxial refractive index ellipsoid, the Rth(λ) is calculated by the following method.

The above-described Re(λ) is measured at 6 points in total by making light at a wavelength of λ nm to be incident from directions inclined with respect to the film normal direction in 10° steps up to 50° on one side from the normal direction with the inclination axis (rotation axis) being the in-plane slow axis (judged by KOBRA 21ADH or WR) (when the slow axis is not present, an arbitrary direction in the film plane is used as the rotation axis) and based on the retardation values measured, the assumed values of average refractive index and the film thickness values input, Rth(λ) is calculated by KOBRA 21ADH or WR.

In the above, when the film has a direction where the retardation value becomes zero at a certain inclination angle from the normal direction with the rotation axis being the in-plane slow axis, the retardation value at an inclination angle larger than that inclination angle is calculated by KOBRA 21ADH or WR after converting its sign into a negative sign.

Incidentally, by measuring the retardation values from two arbitrary inclined directions by using the slow axis as the inclination axis (rotation axis) (when the slow axis is not present, an arbitrary direction in the film plane is used as the rotation axis), Rth can also be calculated based on the values obtained, the assumed values of average refractive index and the film thickness values input, according to the following formulae (1) and (2).

$$Re ( θ ) = [ n x - \frac{ny \times nz}{\sqrt{{\{ ny sin ( {sin}^{- 1} ( \frac{sin ( - θ )}{nx} ) ) \}}^{2} + {\{ nz cos ( {sin}^{- 1} ( \frac{sin ( - θ )}{nx} ) ) \}}^{2}}} ] \times \frac{d}{cos \{ {sin}^{- 1} ( \frac{sin ( - θ )}{nx} ) \}} \qquad Mathematical Formula ( 1 )$$

Re(θ) above represents the retardation value in the direction inclined at an angle of θ from the normal direction.

In mathematical formula (I), nx represents the refractive index in the in-plane slow axis direction, ny represents the refractive index in the direction crossing with nx at right angles in the plane, nz represents the refractive index in the direction crossing with nx and ny at right angles, and d represents the thickness of the film.

$$Rth = [ \frac{nx + ny}{2} - nz ] \times d \qquad Mathematical Formula ( 2 )$$

In the case where the film measured is a film incapable of being represented by a uniaxial or biaxial refractive index ellipsoid or a film not having a so-called optic axis, Rth(λ) is calculated by the following method.

The Re(λ) is measured at 11 points by making light at a wavelength of λnm to be incident from directions inclined with respect the film normal direction in 10° steps from −50° to +50° with the inclination axis (rotation axis) being the in-plane slow axis (judged by KOBRA 21ADH or WR), and Rth(λ) is calculated by KOBRA 21ADH or WR based on the retardation values measured, the assumed values of average refractive index and the film thickness values input.

In the measurement above, as for the assumed value of average refractive index, the values described in Polymer Handbook (John Wiley & Sons, Inc.) and catalogues of various optical films can be used. The average refractive index of which value is unknown can be measured by an Abbe refractometer. For example, the values of average refractive index of main optical films are as follows: cellulose acylate (1.48), cycloolefin polymer (1.52), polycarbonate (1.59), polymethyl methacrylate (1.49) and polystyrene (1.59). When such an assumed value of average refractive index and the film thickness are input, KOBRA 21ADH or WR calculates nx, ny and nz and from these calculated nx, ny and nz, Nz=(nx−nz)/(nx−ny) is further calculated.

In the cellulose compound film of the present invention, Re and Rth can be adjusted by the total substitution degree, the substitution degree distribution at 2-, 3- and 6-positions of substituent, or the stretch ratio.

The fluctuation of the Re(590) value in the film width direction is preferably +5 nm, more preferably ±3 nm, and the fluctuation of the Rth(590) value in the width direction is preferably +10 nm, more preferably ±5 nm. The fluctuations of Re value and Rth value in the length direction are also preferably in respective ranges of fluctuation in the width direction.

### [Equilibrium Water Content]

As regards the method for measuring the water content, the cellulose acylate film sample (7 mm×35 mm) of the present invention is measured using a water content meter or a sample drying apparatus (AQUACOUNTER AQ-200, LE-20S, both manufactured by Hiranuma Sangyo Co., Ltd.) by the Karl Fischer method. The equilibrium water content is calculated by dividing the water amount (g) by the mass (g) of the sample.

The equilibrium water content of the cellulose acylate film of the present invention at 25° C. and 80% RH is preferably from 0 to 3%, more preferably from 0.1 to 2%, still more preferably from 0.3 to 1.5%. If the equilibrium water content exceeds 3%, when used as the support of an optically compensatory film, the film suffers from large dependency of the retardation on the change of humidity and disadvantageously decreases in the optical compensation performance.

In the case of using the cellulose compound film of the present invention for VA mode or OCB mode, two embodiments may be taken, that is, an embodiment using two films in total on both sides by disposing one on each side (two films-type), and an embodiment using the film only on either one side of top and bottom of the cell (one film-type).

In the case of two films-type, Re(590) is preferably from 20 to 100 nm, more preferably from 30 to 70 nm, and Rth(590) is preferably from 70 to 300 nm, more preferably from 100 to 200 nm.

In the case of one film-type, Re(590) is preferably from 30 to 150 nm, more preferably from 40 to 100 nm, and Rth(590) is preferably from 100 to 300 nm, more preferably from 150 to 250 nm.

### [Haze]

The haze value of the cellulose compound film of the present invention as measured using, for example, a haze meter (Model 1001DP, manufactured by Nippon Denshoku Industries Co., Ltd.) is preferably from 0.1 to 0.8, more preferably from 0.1 to 0.7, still more preferably from 0.1 to 0.60. By controlling the haze to fall in this range, when the film is incorporated as an optically compensatory film into a liquid crystal display device, an image in high contrast is obtained.

### (Photoelastic Coefficient)

The cellulose compound film of the present invention is preferably used as a polarizing plate protective film or a retardation plate. In the case of use as a polarizing plate protective film or a retardation plate, the birefringence (Re, Rth) sometimes changes due to a stress caused by elongation or shrinkage resulting from moisture absorption. The change in the birefringence due to such a stress can be measured as a photoelastic coefficient, and the photoelastic coefficient is preferably from 5×10⁻⁷ to 30×10⁻⁷ (cm²/kgf), more preferably from 6×10⁻⁷ to 25×10⁻⁷ (cm²/kgf), still more preferably from 7×10⁻⁷ to 20×10⁻⁷ (cm²/kgf).

### (Surface Treatment)

The unstretched or stretched cellulose compound film is surface-treated depending on the case, whereby the adhesion of the cellulose compound film to each functional layer (for example, an undercoat layer or a back layer) can be enhanced. Examples of the surface treatment which can be used include glow discharge treatment, ultraviolet irradiation treatment, corona treatment, flame treatment and acid or alkali treatment. The glow discharge treatment as used herein may be a low-temperature plasma occurring in a low-pressure gas of 10⁻³ to 20 Torr. A plasma treatment under an atmospheric pressure is also preferred. The plasma-exciting gas means a gas which is plasma-excited under such a condition, and examples thereof include argon, helium, neon, krypton, xenon, nitrogen, carbon dioxide, chlorofluorocarbons such as tetrafluoromethane, and a mixture thereof. These are described in detail in JIII Journal of Technical Disclosure, No. 2001-1745, pp. 30-32, Japan Institute of Invention and Innovation (Mar. 15, 2001). Incidentally, in an atmospheric plasma treatment recently drawing attention, for example, an irradiation energy of 20 to 500 Kgy is used under 10 to 1,000 Kev, and preferably, an irradiation energy of 20 to 300 Kgy is used under 30 to 500 Kev. Among these treatments, an alkali saponification treatment is preferred, and this is very effective as a surface treatment of the cellulose compound film.

### (Optically Anisotropic Layer)

Next, liquid crystalline molecules of the optically anisotropic layer are oriented on an orientation film. Thereafter, if desired, the orientation film polymer and the polyfunctional monomer contained in the optically anisotropic layer are reacted or the orientation film polymer is crosslinked by using a crosslinking agent.

The liquid crystalline molecule used for the optically anisotropic layer includes a rod-like liquid crystalline molecule and a disc-like liquid crystalline molecule. The rod-like liquid crystalline molecule and the disc-like liquid crystalline molecule each may be a polymer liquid crystal or a low molecular liquid crystal. The liquid crystalline molecule also includes a low molecular liquid crystal which is crosslinked and does not exhibit liquid crystallinity any more.

### 1) Rod-Like Liquid Crystalline Molecule

As for the rod-like liquid crystalline molecule, azomethines, azoxys, cyanobiphenyls, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyldioxanes, tolans and alkenylcyclohexylbenzonitriles are preferably used.

A metal complex is also included in the rod-like liquid crystalline molecule. Furthermore, a liquid crystal polymer containing a rod-like liquid crystalline molecule in a repeating unit may be also used as the rod-like liquid crystalline molecule. In other words, the rod-like liquid crystalline molecule may be bonded to a (liquid crystal) polymer.

The rod-like liquid crystalline molecule is described in Kikan Kagaku-Sosetsu (General Chemistry Quarterly), Vol. 22, “Ekisho no Kagaku (Liquid Crystal Chemistry)”, Chapters 4, 7 and 11, compiled by The Chemical Society of Japan (1994); and Ekisho Device Handbook (Liquid Crystal Device Handbook)”, Chapter 3, compiled by Japan Society for the Promotion of Science, the 142th Committee.

The birefringent index of the rod-like liquid crystalline molecule is preferably from 0.001 to 0.7.

The rod-like liquid crystalline molecule preferably has a polymerizable group so as to fix the aligned state of the molecules. The polymerizable group is preferably a radical polymerizable unsaturated group or a cationic polymerizable group, and specific examples thereof include polymerizable groups and polymerizable liquid crystal compounds described in JP-A-2002-62427, paragraphs [0064] to [0086].

### 2) Disc-Like Liquid Crystalline Molecule

The disc-like (discotic) liquid crystalline molecule includes benzene derivatives described in the research report of C. Destrade, et al., Mol. Cryst., Vol. 71, page 111 (1981); truxene derivatives described in the research reports of C. Destrade, et al., Mol. Cryst., Vol. 122, page 141 (1985) and Physics lett., A, Vol. 78, page 82 (1990); cyclohexane derivatives described in the research report of B. Kohne, et al., Angew. Chem., Vol. 96, page 70 (1984); and azacrown-based or phenylacetylene-based macrocycles described in the research report of J. M. Lehn, et al., J. Chem. Commun., page 1794, (1985), and the research report of J. Zhang, et al., J. Am. Chem. Soc., Vol. 116, page 2655 (1994).

The discotic liquid crystalline molecule also includes a compound which has a structure such that a linear alkyl group, an alkoxy group or a substituted benzoyloxy group is radially substituted to a mother nucleus in the center of the molecule as a side chain of the mother nucleus and which exhibits liquid crystallinity. A compound where a molecule or an aggregate of molecules has a rotation symmetry and can impart a certain alignment, is preferred. In the case of forming an optically anisotropic layer from a discotic liquid crystalline molecule, the compound finally contained in the optically anisotropic layer need not be a discotic liquid crystalline molecule, and a compound which is polymerized or crosslinked through a reaction caused by the effect of light to have a high molecular weight and resultantly deprived of liquid crystallinity is also included. Preferred examples of the discotic liquid crystalline molecule are described in JP-A-8-50206. Also, the polymerization of the discotic liquid crystalline molecule is described in JP-A-8-27284.

In order to fix the discotic liquid crystalline molecules by polymerization, a polymerizable group must be bonded as a substituent to the discotic core of the discotic liquid crystalline molecule. A compound allowing for bonding of the polymerizable group to the discotic core through a linking group is preferred and by such bonding, the aligned state can be maintained even at the polymerization reaction. Examples thereof include compounds described in JP-A-2000-155216, paragraphs [0151] to [0168].

In the hybrid alignment, the angle between the long axis (disc plane) of the discotic liquid crystalline molecule and the plane of the polarizing film is increased or decreased as the distance from the plane of the polarizing film in the depth direction of the optically anisotropic layer increases. The angle is preferably decreased as the distance increases. The change of angle may be a continuous increase, a continuous decrease, an intermittent increase, an intermittent decrease, a change containing continuous increase and continuous decrease, or an intermittent change containing increase and decrease. In the intermittent change, a region where the tilt angle does not change is present on the way in the thickness direction. Even when a region having no change of angle is present, it may suffice if the angle is increased or decreased as a whole. It is preferred that the angle is continuously changed.

The average direction of the long axis of the discotic liquid crystalline molecule on the polarizing film side can be generally adjusted by selecting the material for the discotic liquid crystalline molecule or orientation film or by selecting the rubbing method. Also, the long axis (disc plane) direction of the discotic liquid crystalline molecule on the surface side (air side) can be generally adjusted by selecting the kind of the discotic liquid crystalline molecule or additive used together with the discotic liquid crystalline molecule. Examples of the additive used together with the discotic liquid crystalline molecule include a plasticizer, a surfactant, a polymerizable monomer and a polymer. The degree of change in the orientation direction of the long axis can be adjusted similarly to the above by selecting the liquid crystalline molecule or additive.

### (Formation of Optically Anisotropic Layer)

The optically anisotropic layer can be formed by applying a coating solution containing the liquid crystalline molecule and if desired, containing a polymerization initiator described below and other arbitrary components, onto an orientation film.

The solvent used for the preparation of the coating solution is preferably an organic solvent. Examples of the organic solvent include an amide (e.g., N,N-dimethylformamide), a sulfoxide (e.g., dimethylsulfoxide), a heterocyclic compound (e.g., pyridine), a hydrocarbon (e.g., benzene, hexane), an alkyl halide (e.g., chloroform, dichloromethane, tetrachloroethane), an ester (e.g., methyl acetate, butyl acetate), a ketone (e.g., acetone, methyl ethyl ketone) and an ether (e.g., tetrahydrofuran, 1,2-dimethoxyethane). Among these, an alkyl halide and a ketone are preferred. Two or more kinds of organic solvents may be used in combination.

The coating solution can be applied by a known method (e.g., wire bar coating, extrusion coating, direct gravure coating, reverse gravure coating, die coating).

The thickness of the optically anisotropic layer is preferably from 0.1 to 20 μm, more preferably from 0.5 to 15 μm, and most preferably from 1 to 10 μm.

### (Fixing of Aligned State of Liquid Crystalline Molecules)

The aligned liquid crystalline molecules can be fixed while keeping the aligned state. The fixing is preferably performed by a polymerization reaction. The polymerization reaction includes a thermal polymerization reaction using a thermal polymerization initiator, and a photopolymerization reaction using a photopolymerization initiator. A photopolymerization reaction is preferred.

Examples of the photopolymerization initiator include an α-carbonyl compound (described in U.S. Pat. Nos. 2,367,661 and 2,367,670), an acyloin ether (described in U.S. Pat. No. 2,448,828), an α-hydrocarbon-substituted aromatic acyloin compound (described in U.S. Pat. No. 2,722,512), a polynuclear quinone compound (described in U.S. Pat. Nos. 3,046,127 and 2,951,758), a combination of triarylimidazole dimer and p-aminophenyl ketone (described in U.S. Pat. No. 3,549,367), acridine and phenazine compounds (described in JP-A-60-105667 and U.S. Pat. No. 4,239,850), and an oxadiazole compound (described in U.S. Pat. No. 4,212,970).

The amount of the photopolymerization initiator used is preferably from 0.01 to 20 mass %, more preferably from 0.5 to 5 mass %, based on the solid content of the coating solution.

The light irradiation for the polymerization of the liquid crystalline molecule is preferably performed using an ultraviolet ray.

The irradiation energy is preferably from 20 mJ/cm² to 50 J/cm², more preferably from 20 to 5,000 in J/cm², still more preferably from 100 to 800 mJ/cm². In order to accelerate the photopolymerization reaction, the light irradiation may be performed under heating.

A protective layer may also be provided on the optically anisotropic layer.

### [Antireflection Film]

The present invention also relates to an antireflection film comprising a cellulose acylate film and an antireflection layer. The antireflection film can be produced according to a normal production method and may be produced, for example, by referring to JP-A-2006-241433.

### [Polarizing Plate]

The present invention also relates to a polarizing plate comprising a polarizing film and two protective films sandwiching the polarizing film, where at least one of these two protective films is the cellulose acylate film of the present invention. The cellulose acylate film may be laminated to the polarizing film, as a part of an optically compensatory film having an optically anisotropic layer, or as a part of an antireflection film having an antireflection layer. In the case of having other layers, the surface of the cellulose acylate film of the present invention is preferably laminated to the surface of the polarizing film. The polarizing plate can be produced, for example, by referring to JP-A-2006-241433.

### (Image Display Device)

The present invention relates to an image display device comprising at least any one of the cellulose compound film, the phase difference film, the polarizing plate, the optically compensatory film, and the antireflection film.

### <Liquid Crystal Display Device>

The cellulose compound film of the present invention and the polarizing plate, phase difference film or optical film using the cellulose compound film each can be preferably incorporated into a liquid crystal display device. The liquid crystal display device includes a TN type, an IPS type, an FLC type, an AFLC type, an OCB type, an STN type, an ECB type, a VA type, and an HAN type. Also, the cellulose compound film can be preferably used for any of the transmissive, reflective and transflective liquid crystal display devices. Each liquid crystal mode is described below.

### (TN-Type Liquid Crystal Display Device)

The cellulose compound film of the present invention may be used as the support of an optically compensatory sheet in a TN-type liquid crystal display device having a TN-mode liquid crystal cell. The TN-mode liquid crystal cell and TN-type liquid crystal display device are conventionally well known. The optically compensatory sheet for use in the TN-type liquid crystal display device can be produced according to the descriptions in JP-A-3-9325, JP-A-6-148429, JP-A-8-50206 and JP-A-9-26572, or can be produced according to the articles by Mori et al. (Jpn. J. Appl. Phys., Vol. 36, page 143 (1997), Jpn. J. Appl. Phys., Vol. 36, page 1068 (1997)).

### (STN-Type Liquid Crystal Display Device)

The cellulose compound film of the present invention may be used as the support of an optically compensatory sheet in an STN-type liquid crystal display device having an STN-mode liquid crystal cell. In the STN-type liquid crystal display device, the rod-like liquid crystalline molecule in the liquid crystal cell is generally twisted in the range of 90 to 360°, and the product (Δn·d) of the refractive index anisotropy (Δn) of the rod-like liquid crystalline molecule and the cell gap (d) is from 300 to 1,500 nm. The optically compensatory sheet for use in the STN-type liquid crystal display device can be produced according to the description in JP-A-2000-105316.

### (VA-Type Liquid Crystal Display Device)

The cellulose compound film of the present invention is advantageously used particularly as the support of an optically compensatory sheet in a VA-type liquid crystal display device having a VA-mode liquid crystal cell. The optically compensatory sheet for use in the VA-type liquid crystal display device preferably has an Re value of 0 to 150 nm and an Rth value of 70 to 400 nm. In the case of using two optically anisotropic polymer films for the VA-type liquid crystal display device, the Rth value of the film is preferably from 70 to 250 nm. In the case of using one optically anisotropic polymer film for the VA-type liquid crystal display device, the Rth value of the film is preferably from 150 to 400 nm. The VA-type liquid crystal display device may employ an orientation-divided mode described, for example, in JP-A-10-123576.

### (IPS-Type Liquid Crystal Display Device and ECB-Type Liquid Crystal Display Device)

The cellulose compound film of the present invention is suitably used as an optically compensatory sheet or a polarizing plate protective film in an IPS-type liquid crystal display device having an IPS-mode liquid crystal cell and an ECB-type liquid crystal display device having an ECB-mode liquid crystal cell. These modes are a mode of causing the liquid crystal material to align nearly in parallel at the black display time, where the liquid crystal molecules are aligned in parallel to the substrate plane in a voltage-unapplied state to provide black display. In such a mode, the polarizing plate using the cellulose compound film of the present invention contributes to improvement of color tint, enlargement of viewing angle, and elevation of contrast. In these modes, the polarizing plate using the cellulose compound film of the present invention for the protective film disposed between the liquid crystal cell and the polarizing plate (cell-side protective film) out of the protective films of the polarizing plates above and under the liquid crystal cell is preferably used at least on one side of the liquid crystal cell. More preferably, an optically anisotropic layer is disposed between the polarizing plate protective film and the liquid crystal cell and the retardation value of the optically anisotropic layer disposed is set to 2 times or less the Δn·d value of the liquid crystal layer.

### (OCB-Type Liquid Crystal Display Device and HAN-Type Liquid Crystal Display Device)

The cellulose compound film of the present invention is advantageously used also as the support of an optically compensatory sheet in an OCB-type liquid crystal display device having an OCB-mode liquid crystal cell and an HAN-type liquid crystal display device having an HAN-mode liquid crystal cell. In the optically compensatory sheet used for the OCB-type liquid crystal display device or HAN-type liquid crystal display device, a direction where the absolute value of retardation becomes minimum is preferably present neither in the plane nor in the normal direction of the optically compensatory sheet. The optical property of the optically compensatory sheet used for the OCB-type liquid crystal display device or HAN-type liquid crystal display device is also determined by the optical property of optically anisotropic layer, the optical property of support, and the configuration of optically anisotropic layer and support. The optically compensatory sheet for use in the OCB-type liquid crystal display device or HAN-type liquid crystal display device can be produced according to the description in JP-A-9-197397, or can be produced according to the article by Mori et al. (Jpn. J. Appl. Phys., Vol. 38, page 2837 (1999)).

### (Reflective Liquid Crystal Display Device)

The cellulose compound film of the present invention is advantageously used also as an optically compensatory sheet in a TN-type, STN-type, HAN-type or GH (guest-host)-type reflective liquid crystal display device. These display modes have long been well known. The TN-type reflective liquid crystal display device can be produced according to the descriptions in JP-A-10-123478, International Publication No. WO9848320, pamphlet, and Japanese Patent No. 3022477, and the optically compensatory sheet for use in the reflective liquid crystal display device can be produced according to the description in International Publication No. WO00-65384.

### (Other Liquid Crystal Display Devices)

The cellulose compound film of the present invention is advantageously used also as the support of an optically compensatory sheet in an ASM-type liquid crystal display device having an ASM (axially symmetric aligned microcell)-mode liquid crystal cell. The ASM-mode liquid crystal cell is characterized in that the thickness of the cell is maintained by a position-adjustable resin spacer. Other properties are the same as those of the TN-mode liquid crystal cell. The ASM-mode liquid crystal cell and the ASM-type liquid crystal display device can be produced according to the description in the article by Kume et al. (Kume et al., SID 98 Digest, 1089 (1998)).

### EXAMPLES

The present invention is described in greater detail below by referring to Examples, but the present invention is not limited thereto.

### Synthesis Example 1

### Synthesis of Intermediate Compound T-1

In a 5 L-volume three-neck flask equipped with a mechanical stirrer, a thermometer, a cooling tube and a dropping funnel, 200 g of cellulose acetate having a substitution degree or 2.15, 115 mL of pyridine and 2,000 mL of acetone are weighed and stirred at room temperature. Thereto, 160 mL of benzoyl chloride (produced by Aldrich) is slowly added dropwise and after the addition, the mixture is further stirred at 50° C. for 2 hours. After the reaction, the reaction solution is allowed to cool to room temperature and then poured into 20 L of methanol with vigorous stirring, as a result, a white solid matter is deposited. The white solid matter is separated by suction filtration and washed three times with a large amount of methanol. The obtained white solid matter is dried overnight at 60° C. and then vacuum-dried at 90° C. for 6 hours to obtain 215 g of the objective Intermediate Compound T-1 as white powder. The average polymerization degree is found to be 254.

### Synthesis Example 2

### Synthesis of Compound A-4

In a 3 L-volume three-neck flask equipped with a mechanical stirrer, a thermometer, a cooling tube and a dropping funnel, 40 g of Intermediate Compound T-1 obtained by the reaction above and 400 ml of pyridine are weighed and stirred at room temperature. Thereto, 40 mL of n-hexanoyl chloride (produced by Aldrich) is slowly added dropwise and after the addition, the mixture is further stirred at 50° C. for 5 hours. After the reaction, the reaction solution is allowed to cool to room temperature and then poured into 10 L of methanol with vigorous stirring, as a result, a white solid matter is deposited. The white solid matter is separated by suction filtration and washed three times with a large amount of methanol. The obtained white solid matter is dried overnight at 60° C. and then vacuum-dried at 90° C. for 6 hours to obtain 44 g of Compound A-4 as white powder. The average polymerization degree is found to be 254.

### Synthesis Example 3

### Synthesis of Compound A-7

The objective Compound A-7 (45 g) is obtained as white powder in the same manner as in the production of Compound A-4 except for changing 40 mL of n-hexanoyl chloride (produced by Aldrich) to 60 mL of 2-ethylhexanoyl chloride (produced by Aldrich). The average polymerization degree is found to be 255.

### Synthesis Example 4

### Synthesis of Intermediate Compound T-2

The objective Intermediate Compound T-2 (223 g) is obtained as white powder in the same manner as in the production of Intermediate Compound T-1 except for changing 160 mL of benzoyl chloride (produced by Aldrich) to 300 mL of 2-ethylhexanoyl chloride (produced by Aldrich) and changing the amount of pyridine from 230 mL, to 150 mL. The average polymerization degree is found to be 255.

### Synthesis Example 5

### Synthesis of Compound A-10

The objective Compound A-10 (45 g) is obtained as white powder in the same manner as in the production of Compound A-4 except for changing Intermediate Compound T-1 to T-2 and changing 40 mL of n-hexanoyl chloride (produced by Aldrich) to 60 mL of benzoyl chloride (produced by Aldrich). The average polymerization degree is found to be 255.

### Synthesis Example 6

### Synthesis of Intermediate Compound T-3

The objective Intermediate Compound T-3 (235 g) is obtained as white powder in the same manner as in the production of Intermediate Compound T-1 except for changing 160 mL of benzoyl chloride (produced by Aldrich) to 280 mL of octanoyl chloride (produced by Aldrich) and changing the amount of pyridine from 230 mL to 130 mL. The average polymerization degree is found to be 255.

### Synthesis Example 7

### Synthesis of Compound A-13

The objective Compound A-13 (41 g) is obtained as white powder in the same manner as in the production of Compound A-10 except for changing Intermediate Compound T-2 to T-3. The average polymerization degree is found to be 255.

### Synthesis Example 8

### Synthesis of Intermediate Compound T-4

The objective Intermediate Compound T-4 (235 g) is obtained as white powder in the same manner as in the production of Intermediate Compound T-1 except for changing 160 mL of benzoyl chloride (produced by Aldrich) to 400 mL of lauroyl chloride (produced by Aldrich) and changing the amount of pyridine from 230 mL to 180 mL. The average polymerization degree is found to be 253.

### Synthesis Example 9

### Synthesis of Compound A-18

The objective Compound A-18 (42 g) is obtained as white powder in the same manner as in the production of Compound A-10 except for changing Intermediate Compound T-2 to T-4. The average polymerization degree is found to be 253.

### Synthesis Example 10

### Synthesis of Intermediate Compound T-5

The objective Intermediate Compound T-5 (235 g) is obtained as white powder in the same manner as in the production of Intermediate Compound T-1 except for changing 160 mL of benzoyl chloride to 500 mL of octadecanoyl chloride (produced by Aldrich) and changing the amount of pyridine from 230 mL to 200 mL. The average polymerization degree is found to be 253.

### Synthesis Example 11

### Synthesis of Compound A-35

The objective Compound A-35 (46 g) is obtained as white powder in the same manner as in the production of Compound A-10 except for changing Intermediate Compound T-2 to T-5. The average polymerization degree is found to be 253.

### Synthesis Example 12

### Synthesis of Intermediate Compound T-6

The objective Intermediate Compound T-6 (210 g) is obtained as white powder in the same manner as in the production of Intermediate Compound T-1 except for changing the amount of benzoyl chloride from 160 mL to 200 mL and changing the amount of pyridine from 230 mL to 260 mL. The average polymerization degree is found to be 257.

### Synthesis Example 13

### Synthesis of Compound A-9

The objective Compound A-9 (45 g) is obtained as white powder in the same manner as in the production of Compound A-7 except for changing Intermediate Compound T-1 to T-6. The average polymerization degree is found to be 255.

### Synthesis Example 14

### Synthesis of Compound A-20

The objective Compound A-20 (45 g) is obtained as white powder in the same manner as in the production of Compound A-4 except for changing Intermediate Compound T-1 to T-6 and changing 40 mL of n-hexanoyl chloride (produced by Aldrich) to 75 mL of dodecanoyl chloride. The average polymerization degree is found to be 255.

### Synthesis Example 15

### Synthesis of Compound A-37

The objective Compound A-37 (45 g) is obtained as white powder in the same manner as in the production of Compound A-4 except for changing Intermediate Compound T-1 to T-6 and changing 40 mL of n-hexanoyl chloride (produced by Aldrich) to 100 mL of octadecanoyl chloride. The average polymerization degree is found to be 255.

### Synthesis Example 16

### Synthesis of Comparative Compound B-5

The objective Comparative Compound B-5 (225 g) is obtained as white powder in the same manner as in the production of Intermediate Compound T-1 except for changing 160 mL of benzoyl chloride (produced by Aldrich) to 240 g of 4-phenylbenzoyl chloride (produced by Aldrich). The average polymerization degree is found to be 254.

### Synthesis Example 17

### Synthesis of Compound A-8

The objective Compound A-8 (46 g) is obtained as white powder in the same manner as in the production of Compound A-10 except for changing Intermediate Compound T-2 to Comparative Compound B-5. The average polymerization degree is found to be 253.

### Synthesis Example 18

### Synthesis of Asaronyl Chloride

In a 3 L-volume three-neck flask equipped with a mechanical stirrer, a thermometer, a cooling tube and a dropping funnel, 200 g of asaronic acid (produced by Aldrich) and 300 ml of toluene are weighed and stirred at room temperature. Thereto, 560 g of thionyl chloride (produced by Wako Pure Chemical Industries, Ltd.) and 10 ml of dimethylformamide are slowly added dropwise and after the addition, the mixture is further stirred at 80° C. for 1 hour. After the reaction, toluene and unreacted thionyl chloride are removed by distillation under reduced pressure, and 500 ml of hexane is poured into the residue with vigorous stirring, as a result, a white solid matter is deposited. The white solid matter is separated by suction filtration and washed three times with a large amount of hexane. The obtained white solid matter is dried to obtain 195 g of the objective asaronyl chloride.

### Synthesis Example 19

### Synthesis of Compound A-32

The objective Compound A-32 (43 g) is obtained as white powder in the same manner as in the production of Compound A-4 except for changing Intermediate Compound T-1 to T-4 and changing 40 mL, of n-hexanoyl chloride (produced by Aldrich) to 192 g of asaronyl chloride. The average polymerization degree is found to be 255.

### Synthesis Example 20

### Synthesis of Compound A-33

The objective Compound A-33 (47 g) is obtained as white powder in the same manner as in the production of Compound A-4 except for changing Intermediate Compound T-1 to T-4 and changing 40 mL of n-hexanoyl chloride (produced by Aldrich) to 200 mL of 4-heptylbenzoyl chloride. The average polymerization degree is found to be 255.

### Synthesis Example 21

### Synthesis of Comparative Compound B-7

The objective Comparative Compound B-7 (235 g) is obtained as white powder in the same manner as in the production of Intermediate Compound T-1 except for changing cellulose acetate having a substitution degree of 2.15 to cellulose acetate having a substitution degree of 2.44, changing 160 mL of benzoyl chloride to 200 mL of octadecanoyl chloride (produced by Aldrich), and changing the amount of pyridine from 230 mL to 80 mL. The average polymerization degree is found to be 253.

### Synthesis Example 22

### Synthesis of Compound A-34

The objective Compound A-34 (46 g) is obtained as white powder in the same manner as in the production of Compound A-10 except for changing Intermediate Compound T-2 to B-7. The average polymerization degree is found to be 253.

### Synthesis Example 23

### Synthesis of Comparative Compound B-9

The objective Comparative Compound B-9 (202 g) is obtained as white powder in the same manner as in the production of Intermediate Compound T-1 except for changing 160 mL of benzoyl chloride to 150 mL of cyclohexanoyl chloride (produced by Aldrich) and changing the amount of pyridine from 230 mL to 93 mL. The average polymerization degree is found to be 256.

### Synthesis Example 24

### Synthesis of Compound A-38

The objective Compound A-38 (46 g) is obtained as white powder in the same manner as in the production of Compound A-10 except for changing Intermediate Compound T-2 to B-9. The average polymerization degree is found to be 256.

### Synthesis Example 25

### Synthesis of Comparative Compound B-12

The objective Comparative Compound B-12 (212 g) is obtained as white powder in the same manner as in the production of Intermediate Compound T-1 except for changing the amount of benzoyl chloride from 160 mL to 180 mL and changing the amount of pyridine from 230 mL, to 250 mL. The average polymerization degree is found to be 257.

### Synthesis Example 26

### Synthesis of Compound A-21

The objective Compound A-21 (50 g) is obtained as white powder in the same manner as in the production of Compound A-4 except for changing Intermediate Compound T-1 to T-6 and changing 40 mL of n-hexanoyl chloride (produced by Aldrich) to 85 mL of dodecanoyl chloride. The average polymerization degree is found to be 257.

### Synthesis Example 27

### Synthesis of Intermediate Compound T-7

The objective Intermediate Compound T-7 (201 g) is obtained as white powder in the same manner as in the production of Intermediate Compound T-1 except for changing the amount of benzoyl chloride from 160 mL to 130 mL and changing the amount of pyridine from 230 mL to 180 mL. The average polymerization degree is found to be 258.

### Synthesis Example 28

### Synthesis of Compound A-22

The objective Compound A-22 (45 g) is obtained as white powder in the same manner as in the production of Compound A-4 except for changing Intermediate Compound T-1 to T-7 and changing 40 mL, of n-hexanoyl chloride (produced by Aldrich) to 65 mL of dodecanoyl chloride. The average polymerization degree is found to be 258.

### Synthesis Example 29

### Synthesis of Compound A-23

The objective Compound A-23 (43 g) is obtained as white powder in the same manner as in the production of Compound A-4 except for changing Intermediate Compound T-1 to T-7 and changing 40 mL, of n-hexanoyl chloride (produced by Aldrich) to 50 mL of dodecanoyl chloride. The average polymerization degree is found to be 258.

### Synthesis Example 29

### Synthesis of Compound A-24

The objective Compound A-24 (39 g) is obtained as white powder in the same manner as in the production of Compound A-4 except for changing Intermediate Compound T-1 to T-7 and changing 40 mL of n-hexanoyl chloride (produced by Aldrich) to 30 mL of dodecanoyl chloride. The average polymerization degree is found to be 258.

### Synthesis Example 30

### Synthesis of Comparative Compound B-1

The objective Comparative Compound B-1 (43 g) is obtained as white powder in the same manner as in the production of Compound A-4 except for changing Intermediate Compound T-1 to diacetyl cellulose having a substitution degree of 2.15 and changing the amount of n-hexanoyl chloride (produced by Aldrich) from 40 mL to 30 mL. The average polymerization degree is found to be 258.

### Synthesis Example 31

### Synthesis of Comparative Compound B-2

The objective Comparative Compound B-2 (43 g) is obtained as white powder in the same manner as in the production of Compound A-4 except for changing Intermediate Compound T-1 to diacetyl cellulose having a substitution degree of 2.15 and changing 40 mL of n-hexanoyl chloride (produced by Aldrich) to 35 mL of 2-ethylhexanoyl chloride (produced by Aldrich). The average polymerization degree is found to be 258.

### Synthesis Example 32

### Synthesis of Comparative Compound B-3

The objective Comparative Compound B-3 (44 g) is obtained as white powder in the same manner as in the production of Compound A-4 except for changing Intermediate Compound T-1 to diacetyl cellulose having a substitution degree of 2.15 and changing 40 mL of n-hexanoyl chloride (produced by Aldrich) to 23 ml, of benzoyl chloride. The average polymerization degree is found to be 257.

### Synthesis Example 33

### Synthesis of Comparative Compound B-4

The objective Comparative Compound B-4 (46 g) is obtained as white powder in the same manner as in the production of Compound A-4 except for changing Intermediate Compound T-1 to diacetyl cellulose having a substitution degree of 2.15 and changing 120 mL of n-hexanoyl chloride (produced by Aldrich) to 69 mL of benzoyl chloride (produced by Aldrich). The average polymerization degree is found to be 258.

### Synthesis Example 34

### Synthesis of Intermediate Compound T-8

Diacetyl cellulose (acetyl substitution degree: 2.15) (200 g) is dissolved in 1,500 mL of tetrahydrofuran, and 316 mL of pyridine and 927 g of triphenylmethyl chloride are added thereto, followed by stirring at 70° C. for 11 hours. Thereto, 300 mL of methanol is added and after confirming that heat generation is stopped, the resulting solution is mixed with 7,000 mL of methanol to precipitate a polymer. The polymer is continuously washed with methanol at 40 to 50° C. and thereby purified to obtain 236 g of Intermediate Compound T-8.

### Synthesis Example 35

### Synthesis of Intermediate Compound T-9

Intermediate Compound T-9 (82 g) is obtained as white powder in the same manner as in the production of Compound A-4 except for changing 400 mL of pyridine to 800 mL of pyridine, changing 40 g of Intermediate Compound T-1 to 80 g of T-8, and changing 40 mL of n-hexanoyl chloride (produced by Aldrich) to 240 mL of benzoyl chloride (produced by Aldrich).

### Synthesis Example 37

### Synthesis of Comparative Compound B-6

Intermediate Compound T-9 (82 g) is dissolved in 500 parts by mass of dichloromethane, and 31 parts by mass of a 25% hydrobromide acetic acid solution is added thereto. After stirring at room temperature for 5 minutes, 10 parts by mass of triethylamine dissolved in 70 parts by mass of methanol is added, and the solution is further stirred for 20 minutes and then mixed with methanol to precipitate a polymer. The polymer is continuously washed with methanol at 40 to 50° C., then filtered and further vacuum-dried to obtain 45 g of Comparative Compound B-6. The average polymerization degree is found to be 255.

### Synthesis Example 38

### Synthesis of Intermediate Compound T-10

Intermediate Compound T-10 (205 g) is obtained as white powder in the same manner as in the production of Intermediate T-8 except for changing diacetyl cellulose having an acetyl substitution degree of 2.15 to diacetyl cellulose having an acetyl substitution degree of 2.44, changing the amount of pyridine from 316 mL to 250 mL, and changing the amount of triphenylmethyl chloride from 741 g to 560 g.

### Synthesis Example 39

### Synthesis of Intermediate Compound T-11

Intermediate Compound T-11 (215 g) is obtained as white powder in the same manner as in the production of Intermediate Compound T-9 except for changing Intermediate Compound T-8 to T-10 and changing the amount of benzoyl chloride (produced by Aldrich) from 240 mL to 120 mL.

### Synthesis Example 40

### Synthesis of Comparative Compound B-8

Comparative Compound B-8 (41 g) is obtained as white powder in the same manner as in the production of Comparative Compound B-6 except for changing Intermediate Compound T-9 to T-11. The average polymerization degree is found to be 255.

### Synthesis Example 41

### Synthesis of Intermediate Compound T-12

Intermediate Compound T-12 (225 g) is obtained as white powder in the same manner as in the production of Intermediate Compound T-9 except for changing the amount of benzoyl chloride (produced by Aldrich) from 120 mL to 130 mL.

### Synthesis Example 42

### Synthesis of Comparative Compound B-10

Comparative Compound B-10 (41 g) is obtained as white powder in the same manner as in the production of Comparative Compound B-6 except for changing Intermediate Compound T-9 to T-12. The average polymerization degree is found to be 255.

### Synthesis Example 43

### Synthesis of Comparative Compound B-11

Comparative Compound B-11 (200 g) is obtained as white powder in the same manner as in the production of Intermediate Compound T-1 except for changing 160 mL of benzoyl chloride (produced by Aldrich) to 100 mL of lauroyl chloride (produced by Aldrich). The average polymerization degree is found to be 258.

### Synthesis Example 44

### Synthesis of Comparative Compound B-12

The objective Comparative Compound B-12 (210 g) is obtained as white powder in the same manner as in the production of Intermediate Compound T-1 except for changing the amount of benzoyl chloride (produced by Aldrich) from 160 mL to 200 mL. The average polymerization degree is found to be 256.

### Synthesis Example 45

### Synthesis of Compound A-41

The objective Compound A-41 (48 g) is obtained as white powder in the same manner as in the production of Compound A-4 except for changing 40 mL of n-hexanoyl chloride (produced by Aldrich) to 120 mL of benzoyl chloride (produced by Aldrich). The average polymerization degree is found to be 254.

### Example 2

### Preparation of Cellulose Compound Solution

The raw materials shown below are charged into a mixing tank and stirred under heating to dissolve the raw materials, whereby a solution having a cellulose compound solution is prepared. Also, cellulose compound solutions are prepared in the same manner as above by using Cellulose Compounds A-4,7,8,10, 13, 14, 18, 20 to 24, 32 to 35, 37, 38, and B-1 to 12 of the present invention in place of the cellulose acetate having a substitution degree of 2.15.

<Cellulose Compound Solution>

| | |
|---|---|
| Cellulose acetate having a substitution | 100 parts by mass |
| degree of 2.15 | |
| Methylene chloride (first solvent) | 402 parts by mass |
| Methanol (second solvent) | 60 parts by mass |

### <Production of Cellulose Compound Film Samples S-1 to S-32>

562 Parts by mass of a solution having the cellulose compound solution composition is cast using a band casting machine, and the film having a residual solvent amount of 15% is uniaxially transversely stretched under the condition of 160° C. by using, if desired, a tenter to produce Film Sample 001 (Comparative Example, thickness: 80 μm). In the following, unless otherwise indicated, the thickness is 80 μm in all of the films produced. Subsequently, Film Samples S-1 to S-31 are produced in the same manner. The results are shown in Table 2.

TABLE 2

| | | Cellulose | | | | | | Total Substitution | Stretch Ratio | | | | ΔRth |
|---|---|---|---|---|---|---|---|---|---|---|---|---|---|
| | Sample | Compound | Substituent A | DSA | Substituent B | DSB (DSB₆) | DSC | Degree | (%) | Re (590 nm) | Rth (590 nm) | ΔRe (10%-80%) | (10%-80%) |
| Invention | S-1 | A-4 | hexanoyl group | 0.38 | benzoyl group | 0.35 (0.30) | 2.15 | 2.88 | 30 | 55 | 280 | 9 | 15 |
| Comparative | S-2 | B-1 | hexanoyl group | 0.73 | — | — | 2.15 | 2.88 | 30 | 11 | 50 | 5 | 10 |
| Example | | | | | | | | | | | | | |
| Invention | S-3 | A-7 | 2-ethylhexanoyl group | 0.35 | benzoyl group | 0.35 (0.30) | 2.15 | 2.85 | 30 | 73 | 300 | 7 | 10 |
| Comparative | S-4 | B-2 | 2-ethylhexanoyl | 0.70 | — | — | 2.15 | 2.85 | 30 | 42 | 71 | 5 | 4 |
| Example | | | group | | | | | | | | | | |
| Invention | S-5 | A-10 | 2-ethylhexanoyl group | 0.35 | benzoyl group | 0.30 (0.04) | 2.15 | 2.80 | 45 | 54 | −92 | 10 | 12 |
| Invention | S-6 | A-13 | octanoyl group | 0.35 | benzoyl group | 0.30 (0.04) | 2.15 | 2.80 | 45 | 81 | −112 | 11 | 11 |
| Invention | S-7 | A-18 | dodecanoyl group | 0.35 | benzoyl group | 0.30 (0.04) | 2.15 | 2.80 | 60 | 95 | −133 | 9 | 10 |
| Invention | S-8 | A-35 | octadecanoyl group | 0.35 | benzoyl group | 0.30 (0.04) | 2.15 | 2.80 | 60 | 90 | −162 | 8 | 8 |
| Comparative | S-9 | B-3 | — | — | benzoyl group | 0.65 (0.25) | 2.15 | 2.80 | 30 | 30 | −101 | 22 | 20 |
| Example | | | | | | | | | | | | | |
| Invention | S-10 | A-9 | 2-ethylhexanoyl group | 0.3 | benzoyl group | 0.42 (0.35) | 2.15 | 2.87 | 45 | 90 | 281 | 6 | 9 |
| Invention | S-11 | A-20 | dodecanoyl group | 0.3 | benzoyl group | 0.42 (0.35) | 2.15 | 2.87 | 45 | 83 | 265 | 5 | 8 |
| Invention | S-12 | A-37 | octadecanoyl group | 0.3 | benzoyl group | 0.42 (0.35) | 2.15 | 2.87 | 45 | 85 | 260 | 5 | 9 |
| Comparative | S-13 | B-4 | — | — | benzoyl group | 0.82 (0.35) | 2.15 | 2.97 | 30 | 2 | −32 | 20 | 20 |
| Example | | | | | | | | | | | | | |
| Invention | S-14 | A-8 | 2-ethylhexanoyl | 0.5 | phenylbenzoyl | 0.35 (0.35) | 2.15 | 3.0 | 30 | 267 | 764 | 10 | 12 |
| | | | group | | group | | | | | | | | |
| Comparative | S-15 | B-5 | — | — | phenylbenzoyl | 0.35 (.35) | 2.15 | 2.50 | 30 | 243 | 721 | −25 | −68 |
| Example | | | | | group | | | | | | | | |
| Invention | S-16 | A-32 | dodecanoyl group | 0.35 | asaronyl group | 0.30 (0.04) | 2.15 | 2.80 | unstretched | 3 | −161 | 12 | 13 |
| Invention | S-17 | A-33 | dodecanoyl group | 0.35 | 4-heptylbenzoyl | 0.30 (0.04) | 2.15 | 2.80 | unstretched | 5 | −185 | 9 | 11 |
| | | | | | group | | | | | | | | |
| Invention | S-18 | A-41 | dodecanoyl group | 0.35 | benzoyl group | 0.50 (0) | 2.15 | 3.0 | unstretched | 6 | −245 | 8 | 10 |
| Comparative | S-19 | B-6 | — | — | benzoyl group | 0.50 (0) | 2.15 | 2.65 | unstretched | 3 | 12 | 18 | 26 |
| Example | | | | | | | | | | | | | |
| Invention | S-20 | A-34 | octadecanoyl group | 0.28 | benzoyl group | 0.28 (0.07) | 2.44 | 3.0 | 30 | 81 | −150 | 9 | 11 |
| Comparative | S-21 | B-7 | octadecanoyl | 0.28 | — | — | 2.44 | 2.72 | 30 | 6 | 31 | 8 | 10 |
| Example | | | group | | | | | | | | | | |
| Comparative | S-22 | B-8 | — | — | benzoyl group | 0.28 (0.07) | 2.44 | 2.72 | 30 | 72 | −152 | 14 | 34 |
| Example | | | | | | | | | | | | | |
| Invention | S-23 | A-38 | cyclohexanoyl group | 0.38 | benzoyl group | 0.35 (0) | 2.15 | 2.88 | 15 | 100 | −150 | 12 | 18 |
| Comparative | S-24 | B-9 | cyclohexanoyl | 0.38 | — | — | 2.15 | 2.53 | 15 | 56 | 240 | −11 | 20 |
| Example | | | group | | | | | | | | | | |
| Comparative | S-25 | B-10 | — | — | benzoyl group | 0.35 (0) | 2.15 | 2.50 | 15 | 15 | −40 | 18 | 23 |
| Example | | | | | | | | | | | | | |
| Invention | S-26 | A-21 | dodecanoyl group | 0.44 | benzoyl group | 0.41 (0.35) | 2.15 | 3.0 | 75 | 97 | 260 | 6 | 10 |
| Comparative | S-27 | B-11 | dodecanoyl | 0.44 | — | — | 2.15 | 2.59 | 90 | 19 | 52 | 10 | 12 |
| Example | | | group | | | | | | | | | | |
| Comparative | S-28 | B-12 | — | — | benzoyl group | 0.41 (0.35) | 2.15 | 2.56 | 30 | 54 | 330 | 20 | 38 |
| Example | | | | | | | | | | | | | |
| Invention | S-29 | A-22 | dodecanoyl group | 0.25 | benzoyl group | 0.30 (0.30) | 2.15 | 2.70 | 15 | 75 | 156 | 9 | 13 |
| Invention | S-30 | A-23 | dodecanoyl group | 0.2 | benzoyl group | 0.30 (0.30) | 2.15 | 2.65 | 15 | 85 | 161 | 11 | 17 |
| Invention | S-31 | A-24 | dodecanoyl group | 0.1 | benzoyl group | 0.30 (0.30) | 2.15 | 2.55 | 15 | 88 | 170 | 12 | 19 |
| Comparative | S-32 | diacetyl | — | — | — | — | 2.15 | 2.15 | 15 | 40 | 194 | 15 | 36 |
| Example | | cellulose | | | | | | | | | | | |

In the evaluation of the film sample, a part (120 mm×120 mm) of each film sample obtained above is cut out and as for the retardation values, Re and Rth for light at a wavelength of 590 nm under the conditions of 25° C. and 60% RH are measured by “KOBRA 21ADH” (manufactured by Oji Scientific Instruments). Furthermore, ΔRe(10%-80%) and ΔRth(10%-80%), which are each a difference between Re or Rth for light at a wavelength of 590 nm under the conditions of 25° C. and 10% RH and Re or Rth for light at a wavelength of 590 nm under the conditions of 25° C. and 80% RH, are measured. The results obtained are shown in Table 2.

As seen from the results in Table 2, in the film sample obtained from conventional cellulose acylate or Comparative Example, the humidity dependency is large or the developability of retardation is small, whereas in the film of the present invention, the absolute value of retardation is large and both developability of retardation and reduction in humidity dependency can be satisfied.

### Example 3

### Polarizing Plate Protective Film

Elliptically polarizing plate Samples 001 to 007 are produced using the samples of Example 2 by the method described in Example 1 of JP-A-11-316378 and evaluated. The optical properties of the elliptically polarizing plate obtained from the cellulose compound film of the present invention are excellent.

### Example 4

### Liquid Crystal Display Device

Liquid crystal display devices described in Example 1 of JP-A-10-48420, discotic liquid crystal molecule-containing optically anisotropic layers and orientation films obtained by coating polyvinyl alcohol described in Example 1 of JP-A-9-26572, VA-type liquid crystal display devices shown in FIGS. 2 to 9 of JP-A-2000-154261, and OCB-type liquid crystal display devices shown in FIGS. 10 to 15 of JP-A-2000-154261, are produced using Samples 001 to 007 of Example 3 and evaluated. In the device obtained using the cellulose compound film of the present invention, good performance is obtained in all cases.

The cellulose compound composition of the present invention can form a cellulose compound film reduced in the change of in-plane retardation (Re) and retardation (Rth) in the thickness direction due to humidity fluctuation, and at the same time, provides an excellent effect that Re and Rth can be freely controlled in a wide range. The cellulose compound film of the present invention can be suitably used for an optically compensatory sheet, a polarizing plate, a liquid crystal display device and the like and can exert an excellent display performance.

The entire disclosure of each and every foreign patent application from which the benefit of foreign priority has been claimed in the present application is incorporated herein by reference, as if fully set forth.

What is claimed is:

1. A cellulose compound composition comprising:
a cellulose compound that comprises (A) an aliphatic acyl group having a carbon number of 5 to 30 and (B) an acyl group containing an aromatic group.

2. The cellulose compound composition according to claim 1, wherein
the cellulose compound further comprises (C) an aliphatic acyl group having a carbon number of 2 to 4.

3. The cellulose compound composition according to claim 2, wherein
the cellulose compound satisfies a following formula (I):
2.4≦DSA+DSB+DSC≦3.0 Formula (I)
wherein
DSA, DSB and DSC represent substitution degrees of the acyl group (A), the acyl group (B) and the acyl group (C), respectively.

4. The cellulose compound composition according to claim 1, wherein
the cellulose compound satisfies a following formula (II):
0.1<DSA<0.8 Formula (II)
wherein
DSA represents a substitution degree of the acyl group (A).

5. The cellulose compound composition according to claim 1, wherein
the cellulose compound satisfies a following formula (III):
0.1<DSB<0.8 Formula (III)
wherein
DSB represents a substitution degree of the acyl group (B).

6. The cellulose compound composition according to claim 1, wherein
the cellulose compound satisfies a following formula (IV) or (IV-I):
0.7DSB≦DSB₆ Formula (IV)
DSB₆≦0.3DSB Formula (IV-I)
wherein
DSB represents a substitution degree of the acyl group (B), and
DSB₆ represents a substitution degree of the acyl group (B) at 6-position thereof.

7. The cellulose compound composition according to claim 1, wherein
the acyl group (A) is selected from the group consisting of a hexanoyl group, an octanoyl group, a 2-ethylhexanoyl group, a dodecanoyl group, an octadecanoyl group and a cyclohexanoyl group.

8. The cellulose compound composition according to claim 1, wherein
the acyl group (B) is selected from the group consisting of a benzoyl group, a phenylbenzoyl group and a 4-heptylbenzoyl group.

9. A cellulose compound film formed of the cellulose compound composition according to claim 1.

10. A phase difference film comprising the cellulose compound film according to claim 9.

11. An optically compensatory film comprising:
the cellulose compound film according to claim 9; and
an optically anisotropic layer formed by aligning a liquid crystalline compound.

12. An antireflection film comprising:
the cellulose compound film according to claim 9; and
an antireflection layer.

13. A polarizing plate comprising:
a polarizing film; and
two protective films between which the polarizing film is sandwiched,
wherein at least one of the two protective films comprises the cellulose compound film according to claim 9.

14. An image display device comprising:
the cellulose compound film according to claim 9.
